(19) United States
(12) Patent Application Publication
(10) Pub. No.: US 2011/0261977 A1
(43) Pub. Date: Oct. 27, 2011

(54) SIGNAL PROCESSING DEVICE, SIGNAL PROCESSING METHOD AND PROGRAM

(75) Inventor: Atsuo Hiroe, Kanagawa (JP)

(73) Assignee: Sony Corporation, Tokyo (JP)

(21) Appl. No.: 13/071,047

(22) Filed: Mar. 24, 2011

(30) Foreign Application Priority Data
Mar. 31, 2010 (JP) 2010-082436

(51) Int. Cl. H04B 1/00

(52) U.S. Cl. 381/119

(57) ABSTRACT

A signal processing device includes a signal transform unit which generates observation signals in the time frequency domain, and an audio source separation unit which generates an audio source separation result, and the audio source separation unit includes a first-stage separation section which calculates separation matrices for separating mixtures included in the first frequency bin data set by a learning process in which Independent Component Analysis is applied to the first frequency bin data set, and acquires a first separation result for the first frequency bin data set, a second-stage separation section which acquires a second separation result for a second frequency bin data set by using a score function in which an envelope is used as a fixed one, and executing a learning process for calculating separation matrices for separating mixtures, and a synthesis section which generates the final separation results by integrating the first and the second separation results.

### BACKGROUND OF THE INVENTION

1. Field of the Invention

The present invention relates to a signal processing device, a signal processing method, and a program. Furthermore, in detail, the invention relates to a signal processing device, a signal processing method, and a program for separating signals resulting from the mixture of a plurality of signals by using Independent Component Analysis (ICA).

Particularly, the present invention relates to a signal processing device, a signal processing method, and a program which enables the reduction of the computational cost by pruning and interpolation of frequency bins in audio source separation using ICA.

2. Description of the Related Art

First of all, as the related art of the present invention, description will be provided on ICA, further on a reduction process of the computational cost by pruning and interpolation of frequency bins, and finally on problems of the related art. So to speak, the description will be provided in the order of subjects below.

a. Description of ICA

b. Regarding the Reduction Process of Computational Cost by Pruning and Interpolation of Frequency Bins

c. Regarding Problems of the Related Art

[a. Description of ICA]

ICA is one kind of multivariate analysis, and of a technique of separating multidimensional signals by using statistical characters of the signals. For detailed description of ICA, please refer to, for example, “Introduction of Independent Component Analysis” (written by Noboru Murata, Tokyo Denki University Press), or the like.

Hereinbelow, ICA of sound signals, particularly ICA in the time frequency domain will be described.

As shown in FIG. 1, a situation can be assumed where different sounds are made from N number of audio sources and the sounds are observed by n number of microphones. To cause sounds (source signals) emitted from an audio source reach a microphone, time delay, reflection, or the like happens. Hence, signals observed by a microphone k (observation signals) can be expressed by a formula that sums up convolution operations of the source signals and transfer functions for the whole audio sources as shown by Formula [1.1]. The mixtures are called “convolutive mixtures” hereinbelow.

Furthermore, an observation signal of a microphone n is set to be xₙ(t). Thus, observation signals of microphones 1 and 2 are x₁(t) and x₂(t), respectively.

If observation signals for all microphones are expressed by one formula, the formula can be expressed as Formula [1.2] shown below.

$$\begin{matrix}{x}_{k} ( t ) = {\sum }_{j = 1}^{N} {\sum }_{l = 0}^{L} {a}_{kj} ( l ) {s}_{j} ( t - l ) = {\sum }_{j = 1}^{N} \{ {a}_{kj} * {s}_{j} \} & [ 1.1 ] \\ x ( t ) = {A}^{[ 0 ]} s ( t ) + … + {A}^{[ L ]} s ( t - L ) & [ 1.2 ] \\ s ( t ) = [ \begin{matrix}{s}_{1} ( t ) \\ ⋮ \\ {s}_{N} ( t )\end{matrix} ] , x ( t ) = [ \begin{matrix}{x}_{1} ( t ) \\ ⋮ \\ {x}_{n} ( t )\end{matrix} ] , {A}^{[ l ]} = [ \begin{matrix}{a}_{11} ( l ) & … & {a}_{1 N} ( l ) \\ ⋮ & ⋱ & ⋮ \\ {a}_{n 1} ( l ) & … & {a}_{nN} ( l )\end{matrix} ] & [ 1.3 ]\end{matrix}$$

Wherein, x(t) and s(t) each are column vectors having xₖ(t) and sₖ(t) as elements, and A^{[1]} is a matrix of n×N having a^{[1]}ₖⱼ as an element. Hereinbelow, n≧N.

The convolutive mixtures of the time domain are generally expressed by instantaneous mixtures in the time frequency domain, and a process that uses the characteristic is ICA in the time frequency domain.

With regard to the ICA in the time frequency domain, please refer to “19.2.4. Fourier Transform Method” of “Answer Book of Independent Component Analysis”, “Apparatus and Method for Separating Audio Signals or Eliminating Noise” of Japanese Unexamined Patent Application Publication No. 2006-238409, and the like.

Hereinafter, the relationship of the present invention with the related art will mainly be described.

When the both sides of Formula [1.2] above are subjected to short-time Fourier Transform, Formula [2.1] shown below can be obtained.

$$\begin{matrix}X ( ω , t ) = A ( ω ) S ( ω , t ) & [ 2.1 ] \\ X ( ω , t ) = [ \begin{matrix}{X}_{1} ( ω , t ) \\ ⋮ \\ {X}_{n} ( ω , t )\end{matrix} ] & [ 2.2 ] \\ A ( ω ) = [ \begin{matrix}{A}_{11} ( ω ) & ⋯ & {A}_{1 N} ( ω ) \\ ⋮ & ⋱ & ⋮ \\ {A}_{n 1} ( ω ) & ⋯ & {A}_{nN} ( ω )\end{matrix} ] & [ 2.3 ] \\ S ( ω , t ) = [ \begin{matrix}{S}_{1} ( ω , t ) \\ ⋮ \\ {S}_{N} ( ω , t )\end{matrix} ] & [ 2.4 ] \\ Y ( ω , t ) = W ( ω ) X ( ω , t ) & [ 2.5 ] \\ Y ( ω , t ) = [ \begin{matrix}{Y}_{1} ( ω , t ) \\ ⋮ \\ {Y}_{n} ( ω , t )\end{matrix} ] & [ 2.6 ] \\ W ( ω ) = [ \begin{matrix}{W}_{11} ( ω ) & ⋯ & {W}_{1 n} ( ω ) \\ ⋮ & ⋱ & ⋮ \\ {W}_{n 1} ( ω ) & ⋯ & {W}_{nn} ( ω )\end{matrix} ] & [ 2.7 ]\end{matrix}$$

In Formula [2.1] above, ω is the index of a frequency bin, and t is the index of a frame.

If ω is fixed, the formula can be deemed to be instantaneous mixtures (mixtures without time delay). Hence, when observation signals are to be separated, a computation formula [2.5] of the separation results [Y] is prepared, and then a separation matrix W(ω) is determined so as to make each component of the separation results: Y(ω, t) the most independent.

In ICA in the time frequency domain of the related art, a problem, which is called as a permutation problem, occurs that “which component is separated in which channel” is different for each frequency bin. However, with the configuration shown in “Apparatus and Method for Separating Audio Signals or Eliminating Noise” of Japanese Unexamined Patent Application Publication No. 2006-238409, which is a previous patent application by the same inventor as this application, the permutation problem is substantially solved. In order to use this method in the present invention, the solving method of the permutation problem disclosed in Japanese Unexamined Patent Application Publication No. 2006-238409 will be briefly described.

In Japanese Unexamined Patent Application Publication No. 2006-238409, in order to obtain the separation matrix W(ω), Formulas [3.1] to [3.3] shown below are repeatedly executed (or certain times) until the separation matrix W(ω) converges.

$$\begin{matrix}Y ( ω , t ) = W ( ω ) X ( ω , t ) ( t = 1 , … , T ) & [ 3.1 ] \\ Δ W ( ω ) = \{ I + {〈 {ϕ}_{ω} ( Y ( t ) ) {Y ( ω , t )}^{H} 〉}_{t} \} W ( ω ) & [ 3.2 ] \\ W ( ω ) ← W ( ω ) + ηΔ W ( ω ) & [ 3.3 ] \\ Y ( t ) = [ \begin{matrix}{Y}_{1} ( 1 , t ) \\ ⋮ \\ {Y}_{1} ( M , t ) \\ ⋮ \\ {Y}_{n} ( 1 , t ) \\ ⋮ \\ {Y}_{n} ( M , t )\end{matrix} ] = [ \begin{matrix}{Y}_{1} ( t ) \\ ⋮ \\ {Y}_{n} ( t )\end{matrix} ] & [ 3.4 ] \\ {ϕ}_{ω} ( Y ( t ) ) = [ \begin{matrix}{ϕ}_{ω} ( {Y}_{1} ( t ) ) \\ ⋮ \\ {ϕ}_{ω} ( {Y}_{n} ( t ) )\end{matrix} ] & [ 3.5 ] \\ {ϕ}_{ω} ( {Y}_{k} ( t ) ) = \frac{\partial }{\partial {Y}_{k} ( ω , t )} log P ( {Y}_{k} ( t ) ) & [ 3.6 ]\end{matrix}$$

Probability Density Function (PDF) of P(Yₖ(t)):Yₖ(t)

$$\begin{matrix}P ( {Y}_{k} ( t ) ) ∝ exp ( - γ {‖ {Y}_{k} ( t ) ‖}_{2} ) & [ 3.7 ] \\ {‖ {Y}_{k} ( t ) ‖}_{m} = {\{ {\sum }_{ω = 1}^{M} {\vert {Y}_{k} ( ω , t ) \vert}^{m} \}}^{1 / m} & [ 3.8 ] \\ {ϕ}_{ω} ( {Y}_{k} ( t ) ) = - γ \frac{{Y}_{k} ( ω , t )}{{‖ {Y}_{k} ( t ) ‖}_{2}} & [ 3.9 ] \\ γ = {M}^{1 / 2} & [ 3.10 ]\end{matrix}$$

The number of frequency bins per channel M:1 . . . [3.11]

$$\begin{matrix}[ \begin{matrix}{W}_{11} ( 1 ) & & 0 & & {W}_{1 n} ( 1 ) & & 0 \\ & ⋱ & & ⋯ & & ⋱ & \\ 0 & & {W}_{11} ( M ) & & 0 & & {W}_{1 n} ( M ) \\ & ⋮ & & ⋱ & & ⋮ & \\ {W}_{n 1} ( 1 ) & & 0 & & {W}_{nn} ( 1 ) & & 0 \\ & ⋱ & & ⋯ & & ⋱ & \\ 0 & & {W}_{n 1} ( M ) & & 0 & & {W}_{nn} ( M )\end{matrix} ] & [ 3.12 ] \\ X ( t ) = [ \begin{matrix}{X}_{1} ( 1 , t ) \\ ⋮ \\ {X}_{1} ( M , t ) \\ ⋮ \\ {X}_{n} ( 1 , t ) \\ ⋮ \\ {X}_{n} ( M , t )\end{matrix} ] & [ 3.13 ] \\ Y ( t ) = WX ( t ) & [ 3.14 ]\end{matrix}$$

The iterative execution is called “learning” hereinbelow. Formulas [3.1] to [3.3] are applied to all frequency bins, and further Formula [3.1] is applied to all frames of accumulated observation signals. In addition, in Formula [3.2], <>ₜ indicates an average over all frames. The superscript H in upper right of Y(ω,t) is the Hermite transpose (which is the transpose of a vector or a matrix with transforming its elements into the conjugate complex numbers).

The separation result Y(t) is a vector which is expressed by Formula [3.4] and in which elements of all channels and all frequency bins of the separation results are arranged. φ_{ω}(Y(t)) is a vector expressed by Formula [3.5]. Each element of φ_{ω}(Yₖ(t)) is called a score function, and is a logarithmic differentiation of a multi-dimensional (multivariate) probability density function (PDF) of Yₖ(t) (Formula [3.6]). As a multi-dimensional PDF, for example, a function expressed by Formula [3.7] can be used, and in this case, the score function φ_{ω}(Yₖ(t)) is expressed as Formula [3.9].

In those formulae, ∥Yₖ(t)∥₂ is L₂ norm of a vector Yₖ(t) (which obtains a square sum of all elements and has a square root). Lₘ norm obtained by generalizing L₂ norm is defined by Formula [3.8], and L₂ norm can be obtained by having m=2 in Formula [3.8].

γ in Formulas [3.7] and [3.9] is a weight of a score function, and for example, substituted with an appropriate positive constant which is M^{1/2} (a square root of the number of frequency bins). η in Formula [3.3] is a small positive value (for example, about 0.1) which is called a learning rate or a learning coefficient. The value is used for causing ΔW(ω) calculated with Formula [3.2] to be reflected into a separation matrix W(ω) a little bit at a time.

Furthermore, Formula [3.1] indicates separation in one frequency bin (refer to FIG. 2A), separation of all frequency bins can be expressed by one formula (refer to FIG. 2B).

In order to do that, the separation results Y(t) of all frequency bins expressed by Formula [3.4] described above, observation signals X(t) expressed by Formula [3.13] and separation matrices of all frequency bins expressed by Formula [3.12] may be used, and separation can be expressed as Formula [3.14] by using vectors and matrices thereof. The present invention uses both of Formulas [3.1] and [3.14] depending on the necessity.

Furthermore, drawings of X₁ to Xₙ and Y₁ to Yₙ shown in FIGS. 2A and 2B are called spectrograms, and the drawings show that the results of short-time Fourier transform (STFT) are arranged in the frequency bin direction and in the frame direction. The longitudinal direction is frequency bin and the horizontal direction is frame. In Formulas [3.4] and [3.13], a low frequency is written in the upper place, but in spectrograms, a low frequency is drawn in the lower place.

Furthermore, as Xₖ(ω,*), the indication of a frame index t, which is replaced with an asterisk “*”, shows data for all the frames. For example, X₁(ω,*) shown in FIG. 2A indicates data 21 for one horizontal line corresponding to ω-th frequency bin in a spectrogram Xₖ of the observation signals shown in FIG. 2B.

[b. Regarding the Reduction Process of Computational Cost by Pruning and Interpolation of Frequency Bins]

The audio source separation by ICA describe above has a problem of having large computational cost in comparison to the audio source separation by other method. Specifically, there are following points.

(1) A separation matrix cannot be solved in a closed form (a formula in the form of “W=”), thus iterative learning is necessary.

(2) Computational cost proportional to the number of learning loops is necessary.

Furthermore, computational cost for one learning loop is also large.

To be more specific, the computational cost for one learning loop is proportionate to the number of frequency bins and the number of frames of observation signals used in learning, and to a square of the number of channels.

However, a case that there is no solution of the closed form (a formula in the form of “W=”) is in a case of ICA using higher-order statistics. As other kind of ICA, a second-order statistics may be used, and there is a solution of a closed form. However, ICA using the second-order statistics has a problem in that the separation accuracy is lower than that of ICA using higher-order statistics.

In other words, computational cost (O) necessary for learning of ICA is computational cost O(n²MTL), where the number of channels is n, the number of frequency bins is M, the number of frames is T, and the iteration times in the learning process is L.

Furthermore, O is the first letter of “order”, and indicates that the computational cost is proportionate to the value in the parentheses.

Hereinbelow, the computational cost of learning of ICA will be briefly described.

As described before, in a signal separation process by ICA, in order to obtain the separation matrix W(ω), Formulas [3.1] to [3.3] described above are repeatedly executed (or a set number of times) until the separation matrix W(ω) converges.

Places where the computational cost is particularly large in the learning process (repetition of Formulas [3.1] to [3.3]) are terms in which products of a matrix and a vector are computed for all frames, and specifically, the computational cost of the right side of Formula [3.1] and the term of <>ₜ of Formula [3.2].

The computational cost in proportion to the number of frames is necessary for such terms, but since a nonlinear function φ_{ω}(Y(t)) is included in the term of <>ₜ of Formula [3.2], it is necessary each time to calculate the total in a learning loop. In other words, the term of <>ₜ of Formula [3.2] is not able to be calculated in advance before learning.

In order to deal with the problem of the computational cost, a method is suggested that learning of ICA is performed in limited frequency bins, and separation matrices or separation results are presumed with a method other than ICA in the remaining frequency bins. Hereinbelow, limiting frequency bins is called “pruning (of frequency bins)”, and presuming separation matrices and separation results for the remaining frequency bins are called “interpolation (of frequency bins)”.

In other words, reduction of the overall computational cost is possible such that “pruning (of frequency bins)” is performed, and learning of ICA is performed for limited frequency bins, and “interpolation (of frequency bins)” is performed that presumes separation matrices and separation results for remaining frequency bins excluded from targets of the learning process by using the learning results.

As the computational cost of ICA is proportionate to the number of frequency bins, the computational cost can be reduced as much as the frequency bins are thinned out. Then, if the computational cost of the interpolation process for the remaining frequency bins is smaller than a case where ICA is applied, the computational cost is reduced overall.

As what is important in the above strategy is the interpolation method, hereinbelow, description will be provided on the process and problems of the related art, focusing on interpolation.

In a signal separation process to which ICA is applied, the related art that discloses the reduction of the computational cost by pruning process or interpolation process is, for example, as follows.

“Signal Processing Device, Signal Processing Method, and Program” of Japanese Unexamined Patent Application Publication No. 2008-134298

“High-speed Blind Audio Source Separation using Frequency Band Interpolation using a Null Beamformer” by Keiichi Osako, Yasumitsu Mori, Hiroshi Saruwatari, Kiyohiro Shikano, Technical Research Report of The Institute of Electronics, Information and Communication Engineers, EA, Applied Acoustics, 107(120) pp. 25-30, 20070622

“Technique for Speeding Up Blind Audio Source Separation with Frequency Band Interpolation using a Null Beamformer” by Keiichi Osako, Yasumitsu Mori, Hiroshi Saruwatari, Kiyohiro Shikano, Lecture Proceedings of Acoustical Society of Japan, 2-1-2, pp. 549-550, March 2007

The interpolation processes disclosed in the related art above all perform an interpolation process based on the direction of an audio source. In other words, the procedure is as follows.

Step 1: Learning of ICA is applied to limited frequency bins, and the separation matrices are obtained.

Step 2: The direction of an audio source is obtained from the separation matrices for each frequency bin, and the direction of the representative audio source is obtained by striking a balance between frequency bins.

Step 3: Filters corresponding to the separation matrices (separation filters) are obtained from the direction of the audio source for the remaining frequency bins.

The computational cost in the process of Step 3 is smaller than a case where learning of ICA is applied to the frequency bins, the computational cost is reduced overall.

[c. Regarding Problems of the Related Art]

Next, problems of the related are will be described. The interpolation processes in the signal separation process to which ICA described in the above-described Patent Documents and Non-patent Documents is applied are all based on the direction of an audio source. However, the method of being based on the direction of the audio source has a few problems. Hereinbelow, the problems will be described.

### (First Problem)

For the first, information on installation location or installation intervals of microphones is necessary for acquiring the direction of an audio source. For that reason, interpolation is not able to be performed for a sound recorded in an environment with unclear such information. In other words, even though ICA itself has an advantage of “being possible to perform separation even when information pertaining to the arrangement of microphones is unclear”, if the direction of an audio source is used in interpolation, the advantage is nullified.

### (Second Problem)

For the second, another problem is that the direction of the representative audio source obtained in the above Step 2 is not optimum in interpolated frequency bins. This point will be described using FIG. 1 again.

A sound that reaches microphone from an audio source has reflective waves in addition to direct waves as shown in FIG. 1. Furthermore, the reflective waves are not limited to one way, but for simplicity, description will be provided by limiting to one way herein. If the difference in the time of arrival at a microphone between a reflective wave and a direct wave is shorter than in one frame of STFT, both waves are mixed. Hence, in the time frequency domain, for example, signals derived from an audio source 1 shown in FIG. 1 is observed as a signal coming from a direction between the direct waves and the reflective waves. The direction is called a virtual direction of an audio source shown by a dotted line in FIG. 1.

When separation filters are generated from the direction of an audio source, what is necessary is not the direction of direct waves, but is the virtual direction of the audio source. However, since the ratio between the power of the direct wave and that of the reflective wave, the number of reflections (how many times a signal is reflected to reach a microphone), and the like are different for each frequency, the virtual direction of the audio source has different values for each frequency. For this reason, the direction of an audio source obtained in a certain frequency bin is not an optimum direction of an audio source for separation in other frequency bins at all times.

On the other hand, when ICA is applied, separation matrices reflected with the virtual direction of an audio source can be automatically obtained.

### (Third Problem)

For the third, another problem is that separation accuracy decreases in interpolation when there is unevenness in sensitivity of microphones in the method of generating a separation filter from the direction of an audio source. In “High-speed Blind Audio Source Separation using Frequency Band Interpolation by Null Beamformer”, for example, a null beamformer (NBF) is used as a method of interpolation, but NBF is not formed with a sufficient blind area when the sensitivity of a microphone is uneven, thereby decreasing separation accuracy as a result.

On the other hand, when ICA is applied, separation matrices reflected with unevenness of the sensitivity between microphones can be automatically obtained.

What the above-described second and third problems indicate is as follows. In comparison to the case where ICA is applied, interpolation based on the direction of an audio source has a possibility that the computational cost is reduced and also separation accuracy decreases. In other words, there is a trade-off between the computational cost and the separation accuracy.

In order to deal with the second and third problems, what is suggested in “Speed-up Technique of Blind Audio Source Separation using Frequency Band Interpolation by Null Beamformer” is that ICA is to be performed also in remaining frequency bins as a separation filter obtained in NBF as an initial value of a separation matrix, instead of using the filter in separation as is. In addition, a technique is used that frequency bins applied with ICA are increased for a certain number of repetitions, not applying ICA to all remaining frequency bins at a time.

Since learning of ICA can be made to converge in a small number of times if the initial value is appropriate, the computational cost of the method can be small in comparison to a case where ICA is applied to all frequency bins from the beginning. Furthermore, since ICA is applied after NBF, the second and third problems are solved.

This method can finely change the relationship between the computational cost and the separation accuracy. However, the trade-off still remains.

As such, an interpolation method that simultaneously satisfies the following two points has not been presented in the related art until now:

(1) Realizing computational cost smaller than ICA

(2) Realizing separation accuracy with the same level as ICA

### SUMMARY OF THE INVENTION

The present invention takes the above circumstances into consideration, and it is desirable to provide a signal processing device, a signal processing method, and a program that realizes a separation process in which computational cost is reduced in a configuration where a highly accurate separation process is executed in each audio source signal unit by using Independent Component Analysis (ICA).

Furthermore, in a configuration of an embodiment of the intention, it is desirable to provide a signal processing device, a signal processing method and a program that realizes the reduction of computational costs overall, by performing “pruning (of frequency bins)”, executing learning of ICA for limited frequency bins, and performing “interpolation (of frequency bins)” in which separation matrices and separation results are presumed in application of the results of learning for remaining frequency bins that are excluded from targets of the learning process.

According to an embodiment of the present invention, there is provided a signal processing device that includes a signal transform unit which generates observation signals in the time frequency domain by acquiring signals obtained by mixing the output from a plurality of audio sources with a plurality of sensors and applying short-time Fourier transform (STFT) to the acquired signals, and an audio source separation unit which generates an audio source separation results corresponding to each audio source by a separation process for the observation signals, in which the audio source separation unit includes a first-stage separation section which calculates separation matrices for separating mixtures included in the first frequency bin data set selected from the observation signals by a learning process in which Independent Component Analysis (ICA) is applied to the first frequency bin data set, and acquires the first separation results for the first frequency bin data set by applying the calculated separation matrices, a second-stage separation section which acquires second separation results for the second frequency bin data set selected from the observation signals by using a score function in which an envelope, which is obtained from the first separation results generated in the first-stage separation section and represents a power modulation in the time direction for channels corresponding to each of the sensors, is used as a fixed one, and by executing a learning process for calculating separation matrices for separating mixtures included in the second frequency bin data set, and a synthesis section which generates the final separation results by integrating the first separation results calculated by the first-stage separation section and the second separation results calculated by the second-stage separation section.

Furthermore, according to the embodiment of the signal processing device of the invention, the second-stage separation section acquires second separation results for the second frequency bin data set selected from the observation signals by using a score function for which the denominator is set with the envelope and executing a learning process for calculating separation matrices for separating mixtures included in the second frequency bin data set.

Furthermore, according to the embodiment of the signal processing device of the invention, the second-stage separation section calculates separation matrices used for separation in a learning process for calculating the separation matrices for separating mixtures included in the second frequency bin data set so that an envelope of separation results Yₖ corresponding to each of channel k is similar to an envelope rₖ of separation results of the same channel k obtained from the first separation results.

Furthermore, according to the embodiment of the signal processing device of the invention, the second-stage separation section calculates weighted covariance matrices of observation signals, in which the reciprocal of each sample in the envelope obtained from the first separation results is used as the weights, and uses the weighted covariance matrices of the observation signals as a score function in the learning process for acquiring the second separation results.

Furthermore, according to the embodiment of the signal processing device of the invention, the second-stage separation section executes a separation process by setting observation signals other than the first frequency bin data set which is a target of the separation process in the first-stage separation section as a second frequency bin data set.

Furthermore, according to the embodiment of the signal processing device of the invention, the second-stage separation section executes a separation process by setting observation signals including overlapping frequency bins with a first frequency bin data set which is a target of the separation process in the first-stage separation section as a second frequency bin data set.

Furthermore, according to the embodiment of the signal processing device of the invention, the second-stage separation section acquires the second separation results by a learning process to which the natural gradient algorithm is applied.

Furthermore, according to the embodiment of the signal processing device of the invention, the second-stage separation section acquires the second separation results in a learning process to which the Equivariant Adaptive Separation via Independence (EASI) algorithm, the gradient algorithm with orthonormality constraints, the fixed-point algorithm, or the joint diagonalization of weighted covariance matrices of observation signals is applied.

Furthermore, according to the embodiment of the invention, the signal processing device includes a frequency bin classification unit which performs setting of the first frequency bin data set and the second frequency bin data set, in which the frequency bin classification unit performs

(a) a setting where a frequency domain used in the latter process is to be included in the first frequency bin data set;

(b) a setting where a frequency domain corresponding to an existing interrupting sound is to be included in the first frequency bin data set;

(c) a setting where a frequency domain including a large component of power is to be included in the first frequency bin data set; and

a setting of the first frequency bin data set and the second frequency bin data set according to any setting of (a) to (c) above or a setting formed by incorporating a plurality of settings from (a) to (c) above.

Furthermore, according to another embodiment of the invention, a signal processing device includes a signal transform unit which generates observation signals in the time frequency domain by acquiring signals obtained by mixing the output from a plurality of audio sources with a plurality of sensors and applying short-time Fourier transform (STFT) to the acquired signals, and an audio source separation unit which generates audio source separation results corresponding to each audio source by a separation process for the observation signals, and the plurality of sensors are each directional microphones, and the audio source separation unit acquires separation results by calculating an envelope representing power modulation in the time direction for channels corresponding to each of the directional microphones from the observation signals, using a score function in which the envelope is utilized as a fixed one, and executing a learning process for calculating separation matrices for separating the mixtures.

Furthermore, according to still another embodiment of the invention, a signal processing method performed in a signal processing device includes the steps of transforming signal in which a signal transform unit generates observation signals in the time frequency domain by applying short-time Fourier transform (STFT) to mixtures of the output from a plurality of audio sources acquired by a plurality of sensors, and separating audio sources in which an audio source separation unit generates audio source separation results corresponding to audio sources by a separation process for the observation signals, and the separating audio source includes the steps of first-stage separating in which separation matrices for separating mixtures included in the first frequency bin data set selected from the observation signals are calculated by a learning process in which Independent Component Analysis (ICA) is applied to the first frequency bin data set, and the first separation results for the first frequency bin data set are acquired by applying the calculated separation matrices, second-stage separating in which second separation results for the second frequency bin data set selected from the observation signals are acquired by using a score function in which an envelope, which is obtained from the first separation results generated in the first-stage separating and represents power modulation in the time direction for channels corresponding to each of the sensors, is used as a fixed one, and a learning process for calculating separation matrices for separating mixtures included in the second frequency bin data set is executed, and synthesizing in which the final separation results are generated by integrating the first separation results calculated by the first-stage separating and the second separation results calculated by the second-stage separating.

Furthermore, according to still another embodiment of the invention, a program which causes a signal processing device to perform a signal process includes the steps of transforming signal in which a signal transform unit generates observation signals in the time frequency domain by applying short-time Fourier transform (STFT) to mixtures of the output from a plurality of audio sources acquired by a plurality of sensors, and separating audio sources in which an audio source separation unit generates audio source separation results corresponding to audio sources by a separation process for the observation signals, and the separating audio source includes the steps of first-stage separating in which separation matrices for separating mixtures included in the first frequency bin data set selected from the observation signals are calculated by a learning process in which Independent Component Analysis (ICA) is applied to the first frequency bin data set, and first separation results for the first frequency bin data set are acquired by applying the calculated separation matrices, second-stage separating in which second separation results for the second frequency bin data set selected from the observation signals are acquired by using a score function in which an envelope, which is obtained from the first separation results generated in the first-stage separating and represents power modulation in the time direction for channels corresponding to each of the sensors, is used as a fixed one, and a learning process for calculating separation matrices for separating mixtures included in the second frequency bin data set are executed, and synthesizing in which the final separation results are generated by integrating the first separation results calculated by the first-stage separating and the second separation results calculated by the second-stage separating.

The program of the invention is a program that can be provided by a recording medium or a communication medium in a computer-readable form for an image processing device or a computer system that can execute various program codes. A process can be realized according to such a program on an information processing device or a computer system by providing the program in the computer-readable form.

Further objectives, characteristics, and advantages of the invention are clarified by detailed description based on embodiments of the invention to be described and accompanying drawings. Furthermore, a system in the present specification has a logically assembled structure of a plurality of units, and is not limited to units of each structure accommodated in the same housing.

According to the configuration of an embodiment of the invention, a device and a method are provided which enables the reduction in computational cost and the higher accuracy in the audio source separation. To be more specific, a separation process of a first stage is executed for the first frequency bins selected from observation signals formed of the mixtures obtained by mixing the output from a plurality of audio sources. For example, first separation results are generated by obtaining separation matrices from a learning process in which ICA is utilized. Furthermore, an envelope representing power modulation in the time direction for channels is obtained based on the first separation results. The second separation results are generated by executing a separation process of the second stage for the second frequency bin data to which a score function in which an envelope is used as a fixed one is applied. Finally, the final separation results are generated by integrating the first separation results and the second separation results. With the process, the computational cost of a learning process in the second separation process can be drastically reduced.

### BRIEF DESCRIPTION OF THE DRAWINGS

FIG. 1 is a diagram illustrating a situation where different sounds are made from N number of audio sources and the sounds are observed by n number of microphones;

FIGS. 2A and 2B are diagrams illustrating separation for a frequency bin (refer to FIG. 2A) and a separation process for all frequency bins (refer to FIG. 2B);

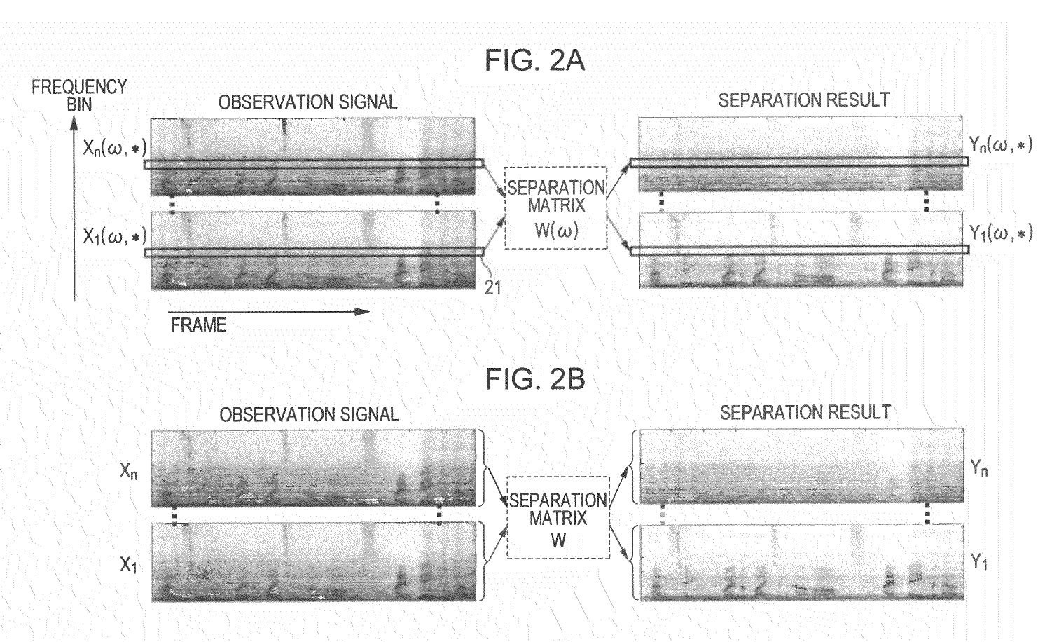

FIGS. 3A to 3C are diagrams illustrating the relationship of signal processes, particularly of “ICA of pair-wise” in an embodiment of the present invention;

FIG. 4 is a diagram illustrating a structural example of a signal processing device according to an embodiment of the present invention;

FIG. 5 is a detailed composition diagram of an audio source separation unit in a signal processing device according to an embodiment of the present invention;

FIG. 6 is a diagram showing a flowchart illustrating the entire process of the signal processing device according to an embodiment of the present invention;

FIGS. 7A and 7B are diagrams illustrating details of a short-time Fourier transform process;

FIG. 8 is a diagram showing a flowchart illustrating details of a separation process of a first stage in Step S104 of the flowchart shown in FIG. 6;

FIG. 9 is a diagram showing a flowchart illustrating details of the separation process of a second stage in Step S105 of the flowchart shown in FIG. 6;

FIG. 10 is a diagram showing a flowchart illustrating details of a different state of the separation process of the second stage in Step S105 of the flowchart shown in FIG. 6;

FIG. 11 is a diagram showing a flowchart illustrating details of a pre-process executed in Step S301 of the flowchart shown in FIG. 9;

FIG. 12 is a diagram showing a flowchart illustrating details of a re-synthesis process in Step S106 in the overall process flow shown in FIG. 6;

FIG. 13 is a diagram illustrating a method of using directional microphones as an audio source separation method other than ICA in the signal separation process of the first stage;

FIG. 14 is a diagram illustrating an environment of a test demonstrating an effect of a signal process of an embodiment of the present invention;

FIGS. 15A to 15B are diagrams illustrating examples of spectrograms of the source signals and observation signals obtained as the experimental results;

FIGS. 16A and 16B are diagrams illustrating separation results in a case where a signal separation process is performed in the related art; and

FIGS. 17A and 17B are diagrams illustrating separation results in a case where a separation process is performed according to an embodiment of the present invention.

### DESCRIPTION OF THE PREFERRED EMBODIMENTS

Hereinbelow, a signal processing device, a signal processing method, and a program will be described in detail with reference to drawings. The description will be provided according to the following subjects.

1. Overview of a Signal Process of the Present Invention

2. Specific Embodiment of a Signal Processing Device of the Present Invention

2-1. Composition of the Signal Processing Device of the Present Invention

2-2. Process of the Signal Processing Device of the Present Invention

3. Modified Example of the Signal Processing Device of the Present Invention

3-1. Modified Example using Another Algorithm in a Signal Separation Process of a Second Stage

(1a) EASI

(1b) Gradient Algorithm with Orthonormality Constraints

(1c) Fixed-Point Algorithm

(1d) Closed Form

3-2. Modified Example using Other Methods than ICA in the Signal Separation Process of a First Stage

4. Explanation of Effect by a Signal Process of the Present Invention

### [1. Overview of a Signal Process of the Present Invention]

First of all, the overview of a composition and a process of the present invention will be described.

The present invention performs a process of separating signals obtained by mixing a plurality of signals by using Independent Component Analysis (ICA).

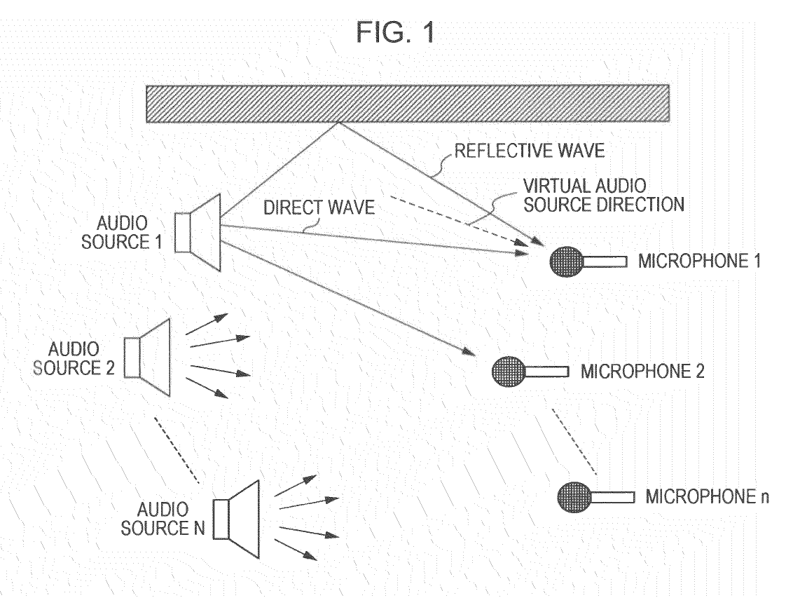

The process of the invention is configured that, for example, different sounds are made from N number of audio sources shown in FIG. 1 described above, the sounds are observed by n number of microphones, and the observation signals of the sounds are used to obtain separation results. A signal observed by a microphone k (observation signal) (=the above-described Formula [1.1]) is acquired, and separation signals are obtained based on the observation signals by using ICA. Observation signals with a microphone n is set to xₙ(t), and observation signals with microphones 1 and 2 are set to x₁(t) and x₂(t) each. In the separation process, it is applied to determine a separation matrix W(ω) so that each component of separation results: Y(ω,t) is independent most based on a calculation formula [2.5] of the separation results [Y].

However, as described above, in a signal separation process by ICA, a learning process is necessary in order to obtain the separation matrix W(ω). In other words, it is necessary for the above-described Formulas [3.1] to [3.3] to be repeatedly executed (or a certain number of times) until the separation matrix W(ω) converges. In the learning process (repetition of Formulas [3.1] to [3.3]), the computational costs are large and the processing costs increase.

In order to reduce the cost of the learning, it is effective to presume separation matrices or separation results by performing the learning of ICA in limited frequency bins as described above, and other method than ICA in remaining frequency bins. In other words, “pruning (of frequency bins)” is performed, and learning of ICA is performed for limited frequency bins, and “interpolation (of frequency bins)” is performed that presumes separation matrices and separation results for remaining frequency bins excluded from targets of the learning process by using the learning results.

As described above, however, with the configuration of the pruning and interpolation processes in the related art, reduction of computational costs without low separation accuracy has not been realized.

The present invention realizes a signal separation process for reducing computational cost without decreasing separation accuracy.

In the invention, learning of ICA is performed by using a special score function in interpolation.

The signal separation process of the invention is executed according o the following procedures (steps).

(Step 1)

Learning of ICA is applied to limited frequency bins, thereby obtaining separation results.

(Step 2)

A common envelope is obtained for each channel by summating envelopes in the time direction of the separation results among the frequency bins used in Step 1.

(Step 3)

Learning is performed for remaining frequency bins by using special ICA that reflects the common envelope to a score function.

Hereinbelow, an overview of each process will be described. Descriptions below are for describing the overview of the present invention, and detailed processes will be described embodiments in the later part.

In the present invention, learning of ICA and similar ICA is used in both of Steps 1 and 3 above, but in order to distinguish the both steps, ICA of Step 1 is expressed as “ICA of a first stage” (or “learning of a first stage” and “separation of a first stage”), and ICA of Step 3 is expressed as “ICA of a second stage” (or “learning of a second stage” “separation of a second stage”) and “ICA in interpolation”.

In addition, since frequency bins themselves are necessary to be distinguished, frequency bin data sets used in Steps 1 and 3 are each called as follows:

Ω^{[1st]} for the frequency bin data set used in ICA of Step 1

Ω^{[2nd]} for the frequency bin data set used in ICA of Step 3.

The elements of Ω^{[1st]} and Ω^{[2nd]} are frequency bin numbers, and it does not matter whether both are overlapped (In other words, a frequency bin to which ICA of the first stage (Step 1) is applied may be applied with interpolation in the second stage (Step 3)). In addition, when the first stage and the second stage are distinguished, the superscripts of [1^{st}] (first stage) and [2^{nd}] (second stage) are given to other variables and functions depending on the necessity.

In Step 1, learning of ICA is performed only for some frequency bins selected from all of the frequencies, that is, limited frequency bins.

Learning in the related art is executed as repetition of Formulas [3.1] to [3.3], but in the learning process of the invention, Formulas [4.4] and [4.5] shown below are used instead of Formula [3.2].

Ω^{[1st]}: a set formed with frequency bins for performing separation of a first stage [4.1]

Ω^{[2nd]}: a set formed with frequency bins for performing separation (interpolation) of a second stage [4.2]

M^{[1st]}: the number of elements of Ω^{[1st]} [4.3]

$$\begin{matrix}{‖ {Y}_{k}^{[ 1 st ]} ( t ) ‖}_{2} = {\{ {\sum }_{ω ∈ {Ω}^{[ 1 st ]}} {\vert {Y}_{k} ( ω , t ) \vert}^{2} \}}^{1 / 2} & [ 4.4 ] \\ Δ W ( ω ) = \{ I + {〈 {ϕ}_{ω}^{[ 1 st ]} ( {Y}^{[ 1 st ]} ( t ) ) {Y ( ω , t )}^{H} 〉}_{t} \} W ( ω ) & [ 4.5 ] \\ {ϕ}_{ω}^{[ 1 st ]} ( {Y}^{[ 1 st ]} ( t ) ) = [ \begin{matrix}{ϕ}_{ω}^{[ 1 st ]} ( {Y}_{1}^{[ 1 st ]} ( t ) ) \\ ⋮ \\ {ϕ}_{ω}^{[ 1 st ]} ( {Y}_{n}^{[ 1 st ]} ( t ) )\end{matrix} ] & [ 4.6 ] \\ {ϕ}_{ω}^{[ 1 st ]} ( {Y}_{k}^{[ 1 st ]} ( t ) ) = - {γ}_{ICA} \frac{{Y}_{k} ( ω , t )}{{‖ {Y}_{k}^{[ 1 st ]} ( t ) ‖}_{2}} & [ 4.7 ] \\ {γ}^{[ 1 st ]} = {( {M}^{[ 1 st ]} )}^{1 / 2} & [ 4.8 ] \\ Q ( ω ) = {〈 {ϕ}_{ω}^{[ 1 st ]} ( {Y}^{[ 1 st ]} ( t ) ) {Y ( ω , t )}^{H} 〉}_{t} & [ 4.9 ] \\ Δ W ( ω ) = \{ I - {〈 Y ( ω , t ) {Y ( ω , t )}^{H} 〉}_{t} + Q ( ω ) - {Q ( ω )}^{H} \} W ( ω ) & [ 4.10 ] \\ Δ W ( ω ) = \{ Q ( ω ) - {Q ( ω )}^{H} \} W ( ω ) & [ 4.11 ] \\ {Y}^{[ 1 st ]} ( t ) = [ \begin{matrix}{Y}_{1} ( {ω}_{1} , t ) \\ ⋮ \\ {Y}_{1} ( {ω}_{{M}^{[ 1 st ]}} , t ) \\ ⋮ \\ {Y}_{n} ( {ω}_{1} , t ) \\ ⋮ \\ {Y}_{n} ( {ω}_{{M}^{[ 1 st ]}} , t )\end{matrix} ] = [ \begin{matrix}{Y}_{1}^{[ 1 st ]} ( t ) \\ ⋮ \\ {Y}_{n}^{[ 1 st ]} ( t )\end{matrix} ] & [ 4.12 ]\end{matrix}$$

In other words, Formulas [3.1], [4.4], [4.5], and [3.3] are repeatedly applied to a frequency bin number ω included in Ω^{[1st]}.

Differences from the learning process in the related art (application of Formulas [3.1] to [3.3] for all frequency bins) are a calculation method of L₂ norm included in the score function (Formulas [4.6] and [4.7]) and a value of a coefficient given to the score function. The L₂ norm is used for calculating the frequency bin data set used in ICA of the first stage (Step 1) only from frequency bins included in Ω^{[1st]} (Formula [4.4]), and a coefficient γ^{[1st]} of the score function is set to a square root of the number of elements M^{[1st]} of Ω^{[1st]} (Formula [4.8]).

The score function used in ICA of the first stage is given with a subscript ω to determine for which of frequency bins the score function is used in order to perform a process dependent on frequency bins. A process dependent on frequency bins is to taking out ω-dimensional element Yₖ(ω,t) from an argument Yₖ(t) which is an M-dimensional vector.

Accordingly, separation results containing consistent permutation are obtained in frequency bins included in Ω^{[1st]}.

In the next Step 2, a time envelope (power modulation in the time direction) is obtained for each channel by using Formula [5.1] shown below.

$$\begin{matrix}{r}_{k} ( t ) = {( {\sum }_{ω ∈ {Ω}^{[ 1 st ]}} {\vert {Y}_{k} ( ω , t ) \vert}^{2} )}^{1 / 2} & [ 5.1 ] \\ {ϕ}^{[ 2 nd ]} ( {Y}_{k} ( ω , t ) , {r}_{k} ( t ) ) = - {γ}^{[ 2 nd ]} \frac{{Y}_{k} ( ω , t )}{{r}_{k} ( t )} & [ 5.2 ] \\ r ( t ) = [ \begin{matrix}{r}_{1} ( t ) \\ ⋮ \\ {r}_{n} ( t )\end{matrix} ] & [ 5.3 ] \\ {ϕ}^{[ 2 nd ]} ( Y ( ω , t ) , r ( t ) ) = [ \begin{matrix}{ϕ}^{[ 2 nd ]} ( {Y}_{1} ( ω , t ) , {r}_{1} ( t ) ) \\ ⋮ \\ {ϕ}^{[ 2 nd ]} ( {Y}_{n} ( ω , t ) , {r}_{n} ( t ) )\end{matrix} ] & [ 5.4 ] \\ Δ W ( ω ) = \{ I + {〈 {ϕ}^{[ 2 nd ]} ( Y ( ω , t ) , r ( t ) ) {Y ( ω , t )}^{H} 〉}_{t} \} W ( ω ) & [ 5.5 ] \\ = W ( ω ) + {〈 {ϕ}^{[ 2 nd ]} ( Y ( ω , t ) , r ( t ) ) {Y ( ω , t )}^{H} 〉}_{t} W ( ω ) & [ 5.6 ] \\ {γ}^{[ 2 nd ]} = {( {M}^{[ 1 st ]} )}^{1 / 2} & [ 5.7 ]\end{matrix}$$

The right side of the above Formula [5.1] is the same as that of the above-described Formula [4.4], and thereby obtaining ∥Yₖ^{[1st]}(t)∥₂ of the time when ICA of the first stage ends.

The formula is applied to all k (the number of channels=the number of observation signals=the number of microphones) and t (the number of frames), thereby obtaining the time envelope. Hereinbelow, “envelope” simply refers to a time envelope.

An envelope shows a similar tendency in any frequency bin if a component is from the same audio source. For example, a moment when an audio source makes a loud sound has a component with a large absolute value in each frequency bin, but a moment when an audio source makes a low sound, the situation is the opposite. In other words, an envelope rₖ(t) calculated from limited frequency bins has a substantially same form as an envelope calculated from all frequency bins (except for a difference in scale). In addition, separation results in a frequency bin to be interpolated from now is supposed to have a substantially same envelope.

Hence, in Step 3, envelopes r₁(t) to rₙ(t) are used as references, and in the channel k, a process is performed in which separation results having a substantially same envelope as the envelope rₖ(t) of the same channel k obtained in a separation process for limited frequency bins of the first stage is “drawn”.

To that end, in Step 3, a score function having rₖ(t) as a denominator is prepared (Formula [5.2]), and for the remaining frequency bins, learning of ICA (the second stage) is performed using the formula. In other words, to a frequency bin number ω included in Ω^{[2nd]}, Formulas [3.1], [5.5] (or Formula [5.6]), and [3.3] are repeatedly applied. However, in Formula [5.5], a modified formula (to be described later) is practically used so that computational cost decreases instead of using the formula as it is.

For γ^{[2nd]} of Formula [5.2], the square root of M^{[1st]} (the number of frequency bins used in ICA of the first stage) may be basically used as γ^{[1st]} (Formula [5.7]).

It is because the denominator rₖ(t) of Formula [5.2] is the sum of M^{[1st]} number of frequency bins as the denominator ∥Yₖ^{[1st]}(t)∥₂ of Formula [4.7].

(Refer to Formulas [5.3] and [5.4] for φ^{[2nd]}(Y(ω,t),r(t)) of Formula [5.5]).

In addition, Formula [5.6] is a formula developing the parenthesis of Formula [5.5], but the formula is obstinately described for the explanation of formulas (7.1 to 7.11) to be described later. The score function of Formula [5.2] takes two arguments in order to be dependent on both of Yₖ(ω,t) and r(t). On the other hand, since there is no process dependent on the frequency bin ω, the subscript of ω is not given.

As a result of the learning of the second stage (Step 3), separation is performed for the frequency bins included in Ω^{[2nd]}, and the separation results containing consistent permutation among all frequency bins are automatically obtained. In other words, the permutation is consistent among the frequency bins included in Ω^{[2nd]}, and between both ICA processes; The first stage (Step 1) and the second stage (Step 3).

By applying Steps 1 to 3, in comparison to a case where Step 1 is applied to all frequency bins, results obtained with the same degree of separation can be obtained with small computational cost.

Next, reasons for following two points will be described.

1. Why separation can be performed with the same accuracy as that of an ICA separation process without the pruning, and the permutation being uniform by the process of the invention.

2. Why computational cost can be reduced by the process of the invention.

(1. Why Separation can be Performed with the Same Accuracy as that of an ICA separation process without the pruning, and the Permutation being Uniform by the Process of the Invention)

First of all, signal separation accuracy and uniformity of permutation in the process of the present invention will be described.

The principle that separation can be performed and the permutation is uniform in Step 3 can be described similarly to “pair-wise separation”. Furthermore, Japanese Unexamined Patent Application Publication No. 2008-92363 described “pair-wise separation”.

“Pair-wise separation” will be briefly described. In addition, “pair-wise separation” will be called “pair-wise ICA” hereinafter.

“Pair-wise ICA” is a technique for performing separation in a pair unit having a dependent relationship when there are separation results desiring a dependent relation among other results. In order to realize such separation, a multivariate probability density function that has signals desiring to have a dependent relationship and a multivariate score function elicited from the probability density function are used in learning of ICA.

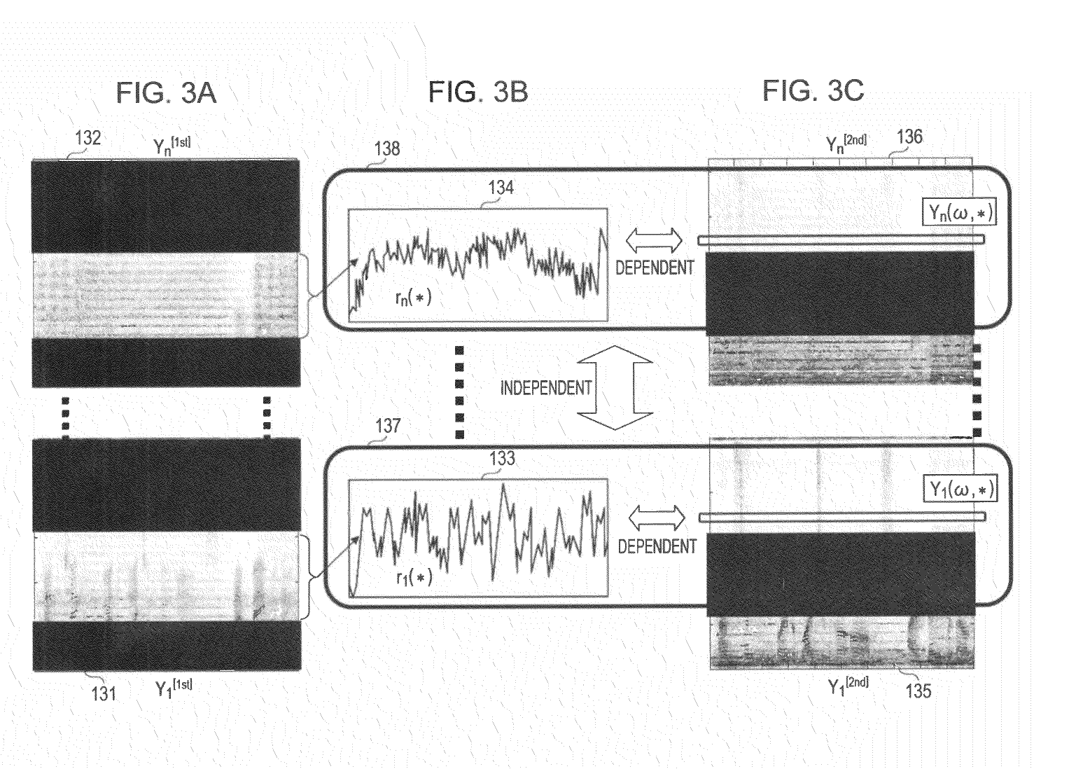

The signal process in the invention, particularly the relationship with “pair-wise ICA” will be described with reference to FIGS. 3A to 3C. Separation results Y₁^{[1st]} to Yₙ^{[1st]}, which are 131 and 132 shown in the separation results of the first stage in FIG. 3A, are separation results obtained in learning in the ICA separation process of the first stage (Step 1). The portion masked with the color black on the spectrogram in (a) separation results of the first stage indicates frequency bins that are not used in learning of the first stage. The gray portion indicates the separation results corresponding to frequency bins selected as processing targets by the pruning process.

In 133 to 134 of signals r₁(*) to rₙ(*) indicating envelopes (fixed) in FIG. 3B, the vertical axis corresponds to signal power and the horizontal axis to time. The graphs shown in FIG. 3B indicate power changes in the time direction, and envelopes obtained in the ICA separation process for limited frequency bins of the first stage.

In other words, 133 to 134 of signals r₁(*) to rₙ(*) indicating envelopes (fixed) in FIG. 3B are envelopes in the time direction (power changes in the time direction) obtained from the separation results 131 to 132 of Y₁^{[1st]} to Yₙ^{[1st]}. In addition, the asterisk “*” indicates data for all frames.

Furthermore, the separation results 135 to 136 of Y₁^{[2nd}] to Yₙ^{[2nd]} shown in the separation results of the second stage in FIG. 3C are separation results corresponding to ω-th frequency bin in learning of the second stage (Step 3). However, it is in the middle of the learning and the separation results are assumed not to converge. In the learning of the second stage, it is hoped for the envelope of Yₖ(ω,*) to be separated so as to be similar to rₖ(*). In other words, in the k-th channel, it is hoped for an envelope similar to rₖ(*) to appear among n-number separation results. To that end, pairs of 137 [r₁(*), Y₁(ω,*)] to 138 [rₙ(*), Yₙ(ω,*)] are considered, and separation matrices may be determined so that pairs are independent from each other and elements in pairs have a dependent relationship.

In order to perform such separation, a probability density function that takes the pair of [rₖ(*), Yₖ(ω,*)] in the argument (in other words, two-dimensional probability density function) is prepared, it is set to P(rₖ(*), Yₖ(ω,*)). This is a setting shown in the left side of Formula [6.1] below. Furthermore, as a score function, logarithmic differentiation of the probability density function is used (Formula [6.2]).

$$\begin{matrix}P ( {Y}_{k} ( ω , t ) , {r}_{k} ( t ) ) = exp ( - {{γ}^{[ 2 nd ]} ( {\vert {Y}_{k} ( ω , t ) \vert}^{2} + {{r}_{k} ( t )}^{2} )}^{1 / 2} ) & [ 6.1 ] \\ {ϕ}^{[ 2 nd ]} ( {Y}_{k} ( ω , t ) , {r}_{k} ( t ) ) = \frac{\partial }{\partial {Y}_{k} ( ω , t )} log P ( {Y}_{k} ( ω , t ) , {r}_{k} ( t ) ) & [ 6.2 ] \\ = - {γ}^{[ 2 nd ]} \frac{{Y}_{k} ( ω , t )}{{( {\vert {Y}_{k} ( ω , t ) \vert}^{2} + {{r}_{k} ( t )}^{2} )}^{1 / 2}} & [ 6.3 ] \\ = - {γ}^{[ 2 nd ]} \frac{\vert {Y}_{k} ( ω , t ) \vert}{{( {\vert {Y}_{k} ( ω , t ) \vert}^{2} + {{r}_{k} ( t )}^{2} )}^{1 / 2}} \frac{{Y}_{k} ( ω , t )}{\vert {Y}_{k} ( ω , t ) \vert} & [ 6.4 ] \\ \approx - {γ}^{[ 2 nd ]} \frac{\vert {Y}_{k} ( ω , t ) \vert}{{r}_{k} ( t )} \frac{{Y}_{k} ( ω , t )}{\vert {Y}_{k} ( ω , t ) \vert} & [ 6.5 ] \\ = - {γ}^{[ 2 nd ]} \frac{{Y}_{k} ( ω , t )}{{r}_{k} ( t )} & [ 6.6 ] \\ \frac{\vert {Y}_{k} ( ω , t ) \vert}{{( {\vert {Y}_{k} ( ω , t ) \vert}^{2} + {{r}_{k} ( t )}^{2} )}^{1 / 2}} \approx \frac{\vert {Y}_{k} ( ω , t ) \vert}{{r}_{k} ( t )} & [ 6.7 ]\end{matrix}$$

If Formula [6.1] is used as the probability density function, Formula [6.3] is elicited as a score function, where γ^{[2nd]} is a weight of the score function, and has the same value as that of γ^{[1st]}, but a different value may be used.

Formula [6.3] finally comes down to Formula [5.2] based on the approximation below. The process will be described. Furthermore, when the learning of the second stage is performed by using Formula [6.3] instead of Formula [5.2], separation itself is possible, but there is no advantage of reduction in computational cost.

If absolute values of Yₖ(ω,t) and rₖ(t) are compared, when M^{[1st]} is sufficiently larger than 1, a relationship of |Yₖ(ω,t)|<<rₖ(t) (“<<” is a signal indicating “the latter one is far larger than the former one”) is established. The reason is that rₖ(t) is the sum of M^{[1st]} number of frequency bins while Yₖ(ω,t) is a value of one frequency bin. In this case, the approximation of Formula [6.7] is established. The approximation has the same meaning that sin θ approximates to tan θ when the absolute value of an angle θ is close to 0.

Formula [6.3] can be applied with the approximation of Formula [6.7] with modification as Formula [6.4]. As a result, Formula [6.6] is obtained through Formula [6.5]. The formula is the same as Formula [5.2].

In other words, if learning is performed by using the score function of Formula [5.2], separation that satisfies the following two points is approximately performed.

(1) Independence is at the maximum in a unit of pair which is an envelope rₖ(*) and separation results Yₖ(ω,*).

(2) An envelope rₖ(*) and separation results Yₖ(ω,*) in a pair are similar to an envelope in the time direction.

As such, after the pruning, an ICA separation process only for the limited frequency bins of the first stage (Step 1) is performed, a pair of an envelope rₖ(*) and separation results Yₖ(ω,*) are set in the second stage (Step 3) by using the envelope (power modulation in the time direction) obtained by the separation process, a separation process of the second stage is executed so that separation matrices where elements in the pair have dependent relationship while pairs are independent is obtained, and thereby an effect can be obtained which separation can be performed with the same degree of accuracy as that of the ICA separation process without the pruning, and even permutation is uniform.

### (2. Why Computational Cost can be Reduced by the Process of the Invention)

Next, the reason why computational cost can be reduced by the process of the invention will be described.

In the process of the invention, the ICA separation process is executed only for selected frequency bins in the first stage (Step 1).

However, learning is performed by using a special ICA in which a common envelope is reflected into a score function as described above, in the second stage (Step 3). If the computational cost of the learning process in the second stage (Step 3) is the same as that of ICA in the related art, reduction in computational cost is not realized overall.

The computational cost of the learning process in the second stage (Step 3) will be described. The learning process of ICA in the related art is repetition of Formulas [3.1] to [3.3] as described above.

As described above, in the learning process in the second stage (Step 3) in the process of the invention, a learning process is performed in which Formulas [3.1], [5.5] (or Formula [5.6]), and [3.3] are repeatedly applied to the frequency bin data set Ω^{[2nd]} used in ICA of Step 3. However, for Formula [5.5], a modified formula is practically used so that computational cost decreases instead of using the formula as it is.

The computational cost of Formula [5.5] itself is the same as that of Formula [3.2] and dependent on the number of frames T. However, Formula [5.5] can be modified into a formula that is not dependent on T, and by doing so, the computational cost of ICA of the second stage can be drastically reduced. Such process will be described by using Formulas [7.1] to [7.11] shown below.

$$\begin{matrix} {W}_{k} ( ω ) = [ {W}_{k 1} ( ω ) ⋯ {W}_{k 1} ( ω ) ] & [ 7.1 ] \\ Δ {W}_{k} ( ω ) = [ Δ {W}_{k 1} ( ω ) ⋯ Δ {W}_{k 1} ( ω ) ] & [ 7.2 ] \\ {Y}_{k} ( ω , t ) = {W}_{k} ( ω ) X ( ω , t ) & [ 7.3 ] \\ Δ {W}_{k} ( ω ) = {W}_{k} ( ω ) + {〈 {ϕ}^{[ 2 nd ]} ( {Y}_{k} ( ω , t ) , {r}_{k} ( t ) ) {Y ( ω , t )}^{H} 〉}_{t} W ( ω ) & [ 7.4 ] \\ {〈 {ϕ}^{[ 2 nd ]} ( {Y}_{k} ( ω , t ) , {r}_{k} ( t ) ) {Y ( ω , t )}^{H} 〉}_{t} = - {γ}^{[ 2 nd ]} {W}_{k} ( ω ) {〈 \frac{1}{{r}_{k} ( t )} X ( ω , t ) {X ( ω , t )}^{H} 〉}_{t} {W ( ω )}^{H} & [ 7.5 ] \\ = - {W}_{k} ( ω ) {C}_{k} ( ω ) {W ( ω )}^{H} & [ 7.6 ] \\ {C}_{k} ( ω ) = {γ}^{[ 2 nd ]} {〈 \frac{1}{{r}_{k} ( t )} X ( ω , t ) {X ( ω , t )}^{H} 〉}_{t} & [ 7.7 ] \\ Δ {W}_{k} ( ω ) = {W}_{k} ( ω ) - {W}_{k} ( ω ) {C}_{k} ( ω ) {W ( ω )}^{H} W ( ω ) & [ 7.8 ] \\ {U}_{k} ( ω ) = - {W}_{k} ( ω ) {C}_{k} ( ω ) {W ( ω )}^{H} & [ 7.9 ] \\ U ( ω ) = [ \begin{matrix}{U}_{1} ( ω ) \\ ⋮ \\ {U}_{n} ( ω )\end{matrix} ] & [ 7.10 ] \\ Δ W ( ω ) = \{ I + U ( ω ) \} W ( ω ) & [ 7.11 ]\end{matrix}$$

First of all, for a separation matrix W(ω) and its change ΔW(ω), vectors obtained by extracting k-th row therefrom are prepared, and each of them are set to Wk(ω) and ΔWk(ω) (Formulas [7.1] and [7.2]).

Then, Yₖ(ω,t) which is the k-th element of the separation result Y(ω,t) of ICA can be shown as Formula [7.3].

If a formula for the elements in the k-th row is extracted from Formula [5.6] by using the variables, it can be expressed as Formula [7.4]. <>ₜ in the formula is an average for the all frames, and if the operation is performed several times in the loop of the learning, the computational cost increases. Hence, the portion is modified as Formula [7.5] by using the relationship of Formulas [5.2], [5.3], and [7.3].

Since the term of <>ₜ in the right side of formula [7.5] is constant in the learning of the second stage, it may be calculated only one time before the learning of the second stage. If the term is put with Cₖ(ω) in combination of γ^{[2nd]} (Formula [7.7]), the left side of Formula [7.5] can be seen as Formula [7.6]. Finally, Formula [7.4] can be modified as Formula [7.8].

In Formula [7.8], it is not necessary for an average operation (the operation of <>ₜ) to be performed in the learning loop. In addition, since the formula does not include the separation results Y(ω,t), it is not necessary to perform Formulas [3.1] and [7.3]. In short, learning may be repeated such that Formula [3.3] is performed after Formula [7.8] is performed for every k, and the computational cost is not dependent on the number of frames. Therefore, in comparison to a case where ICA of the first stage is applied to all of the frequency bins (the method of the related art), the effect of reducing computational cost is present as the number of frames is large.

Furthermore, if Formula [7.6] is placed with Uₖ(ω) and a matrix U(ω) having U₁(ω) to Uₙ(ω) as row vectors is used, an updating formula of Δ W(ω) can be seen as Formula [7.11].

In other words, in the learning process of the second stage (Step 3), Formulas [7.9], [7.10], [7.11], and [3.3] may be repeatedly applied instead of repetition of Formulas [3.1] to [3.3] used in the learning process of the related art, and the computational cost can be largely reduced with the formulas not being dependent on the number of frames T. Specifically, the computational cost per frequency bin in the learning process of the second stage can be about 1/T.

Furthermore, the process described with reference to Formulas [7.1] to [7.11] described above is for a formula using an algorithm called a natural gradient method, but the formula can be modified to a formula having small computational cost for other algorithms. Details thereof will be described in [3. Modified Example of the Signal Processing Device of the Present Invention] in the latter part.

Furthermore, compared with <X(ω,t)X(ω,t)^{H}>ₜ, a covariance matrix of observation signals, Cₖ(ω) in Formula [7.7] can be considered as a mean of X(ω,t)X(ω,t)^{H} together with weights 1/rₖ(t). Thus, Cₖ(ω) is called “a weighted covariance matrix (of observation signals)” hereinafter.

### [2. Specific Embodiments of a Signal Processing Device of the Present Invention]

Next, a specific embodiment of a signal processing device of the present invention will be described.

### (2-1. Composition of the Signal Processing Device of the Present Invention)

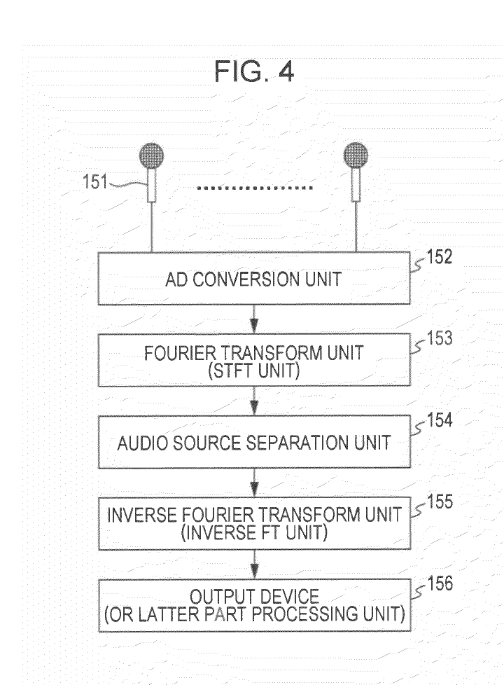

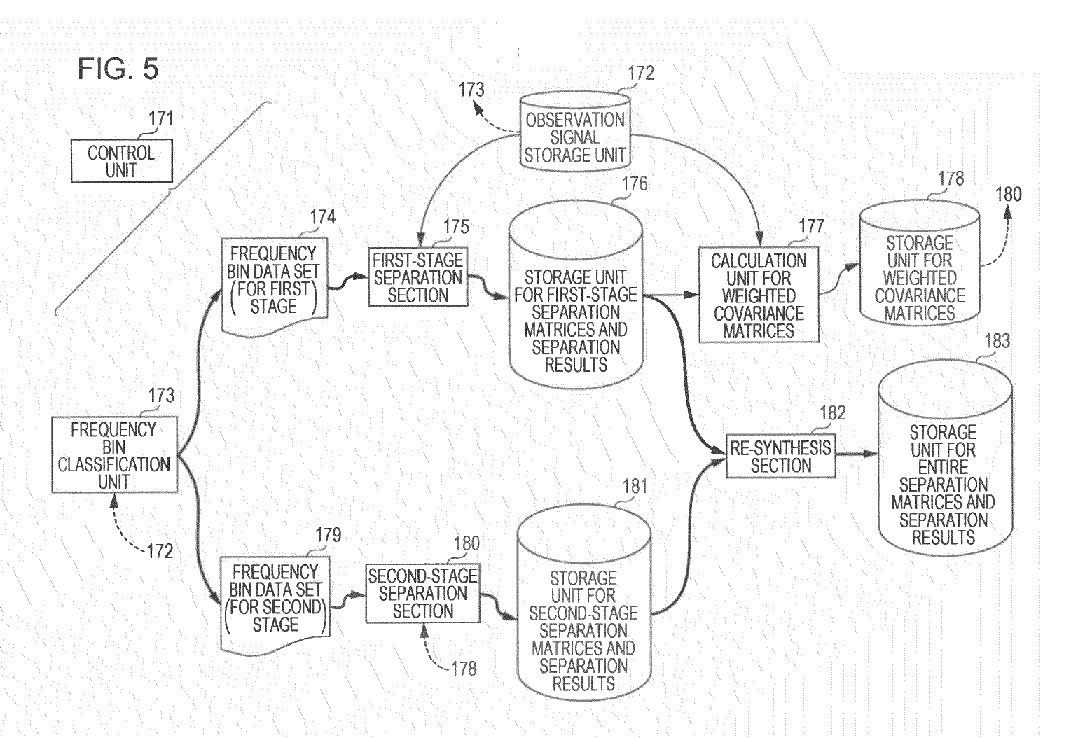

A composition example of the signal processing device of the present invention will be described with reference to FIGS. 4 and 5.

FIG. 4 is the composition of the entire signal processing device, and FIG. 5 is a detailed composition diagram of an audio source separation unit 154 in the signal processing device shown in FIG. 4.

Sound data collected by a plurality of microphones 151 are converted from analog signals to digital signals in an AD conversion unit 152. Next, short-time Fourier transform (STFT) is applied in a Fourier transform unit (STFT unit) 153, and the digital signals are converted into signals of the time frequency domain. The signals are called as observation signals. Details of the process of STFT will be described later.

The observation signals in the time frequency domain generated by STFT are input to an audio source separation unit 154, and separated into independent components by a signal separation process executed in the audio source separation unit 154.

Furthermore, in the signal separation process executed in the audio source separation unit 154, “pruning (of frequency bins” described before is performed, learning of ICA is executed for limited frequency bins, and a process of “interpolation (of frequency bins)” is executed in which separation matrices and separation results obtained by applying a learning result to remaining frequency bins excluded from targets of the learning process are presumed by using the learning results. In other words, processes of Steps 1 to 3 below, which are described in [1. Overview of a Signal Process of the Present Invention] before, are executed.

(Step 1)

Learning of ICA is applied to limited frequency bins, thereby obtaining separation results.

(Step 2)

A common envelope is obtained for each channel by summating envelopes in the time direction of the separation results among the frequency bins used in Step 1.

(Step 3)

Learning is performed in remaining frequency bins by using special ICA that reflects the common envelope to a score function.

Details of the processes will be described later.

The separation results as the results with the process by the audio source separation unit 154 is input to an inverse Fourier transform unit (inverse FT unit) 155, inverse Fourier transform is executed, and the results are transformed into signals in the time domain.

The separation results of the time domain are sent to an output device (or a latter part processing unit) 156 and further processed depending on the necessity. In addition, the output device (or a latter part processing unit) 156 includes, for example, a speech recognition device, a recording device, a voice communication device, and the like. Furthermore, when the latter part processing unit is also a device for performing the short-time Fourier transforming (STFT) process, it is possible to employ a configuration where the STFT process in the output device (or a latter part processing unit) 156 and the inverse Fourier transform unit (inverse FT unit) 155 are omitted.

Next, the detailed composition and process of the audio source separation unit 154 will be described with reference to FIG. 5.

A control unit 171 is for controlling each module of the audio source separation unit 154, and each module is assumed to be connected by an input-output line (not shown in the drawing) of control signals.

An observation signal storage unit 172 is a buffer for storing observation signals in the time frequency domain. The data are used in learning of the first stage and calculation of weighted covariance matrices. Furthermore, the data are also used in a first-stage separation section 175 according to a separation method.

A frequency bin classification unit 173 classifies two sets of frequency bins based on a certain criterion. The two sets are a frequency bin data set (for the first stage) 174 applied to learning of the first stage, and a frequency bin data set (for the second stage) 179 applied to learning of the second stage. The criterion of the classification will be described later.

In each of the frequency bin data sets, it is not necessary for observation signals to be stored, but indexes of the observation signals, for example, frequency bin indices may be stored. In addition, if the sum of the two sets coincides with the all frequency bins, it does not matter that overlapping portions are present in the both sets. For example, a configuration where a frequency bin data set (for the first stage) 174 is for limited frequency bins and a frequency bin data set (for the second stage) 179 is for all frequency bins is possible.

A first-stage separation section 175 performs a learning process for calculating separation matrices in Independent Component Analysis (ICA) for frequency bins included in the frequency bin data set (for the first stage) 174, and stores the separation matrices and separation results resulted therefrom in a storage unit for the first-stage separation matrices and separation results 176.

A calculation unit for weighted covariance matrices 177 calculates any of a value of Cₖ(ω) of the above-described Formula [7.7] and values related thereto, for example, a value out of various values used in the learning of the second stage, which can be calculated before the learning, and stores the results in a storage unit for weighted covariance matrices 178.

Furthermore, as described before, when Cₖ(ω) of Formula [7.7] is compared to <X(ω,t)X(ω,t)^{H}>ₜ, a covariance matrix of observation signals, Cₖ(ω) can be regarded to be a mean of X(ω,t)X(ω,t)^{H} together with the weights 1/rₖ(t), thus Cₖ(ω) of Formula [7.7] is called a “weighted covariance matrix (of observation signals)”.

A second-stage separation section 180 performs a separation process of the second stage for frequency bins included in the frequency bin data set (for the second stage) 179, and stores separation matrices and separation results, which are results thereof, in a storage unit for second-stage separation matrices and separation results 181.

A re-synthesis section 182 generates separation matrices and separation results of all the frequency bins by synthesizing the data stored in the storage unit for first-stage separation matrices and separation results 176 and the data stored in the a storage unit for second-stage separation matrices and separation results 181.

Furthermore, the storing process for the separation results can be appropriately omitted in the following storage units:

the storage unit for the first-stage separation matrices and separation results 176;

the storage unit for the second-stage separation matrices and separation results 181; and

a storage unit for the entire separation matrices and separation results 183.

The reason for this is, if there are the separation matrix W(ω) and the observation signal X(ω, t), the separation result Y(ω, t) can be easily generated by using the relationship of Formula [3.1] shown above.

### (2-2. Process of the Signal Processing Device of the Present Invention)

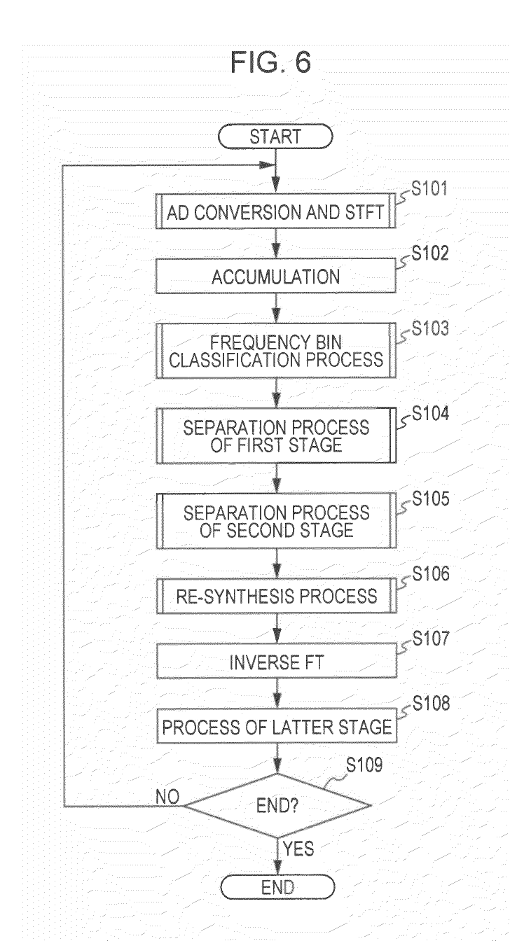

Next, the overall process of the signal processing device of the invention will be described with reference to the flowchart in FIG. 6.

First of all, in Step S101, for signals input from the microphones, an AD conversion process and short-time Fourier transform (STFT) are executed. This is the process executed in the AD conversion unit 152 and the Fourier transform unit (STFT unit) 153 shown in FIG. 4.

Analogue sound signals input to the microphones are converted into digital signals, and further converted into signals of the time frequency domain by STFT. The input may be performed from a file, a network, or the like in addition to the input from a microphone. Details of STFT will be described later.

Furthermore, since the number of input channels is plural (as many as the number of microphones), AD conversion and Fourier transform are performed as many as the number of channels. Hereinbelow, the results with Fourier transform for all channels and one frame are indicated as a vector X(t). It is the vector expressed by Formula [3.13] shown above.

Furthermore, in Formula [3.13], n is the number of channels (=the number of microphones). M is the total of frequency bins M=L/2+1, letting L be points in STFT.

An accumulation process of the next Step S102 is a process of accumulating observation signals converted in the time frequency domain by STFT for a predetermined period of time (for example, for 10 seconds). To put it differently, letting T be the number of frames corresponding to the period, observation signals for consecutive T frames are accumulated in a storage unit (buffer). It is a storing process for the observation signal storage unit 172 shown in FIG. 5.

A frequency bin classification process of the next Step S103 is a process of determining which of learning between in the first stage and in the second stage (or both) M number of frequency bins is used. It is a process executed by the frequency bin classification unit 173 shown in FIG. 5. The criterion of classification will be described later. Hereinbelow, frequency bin data sets generated as results of the classification are each defined as below.

Ω^{[1st]} for the frequency bin data set used in ICA of the first stage

Ω^{[2nd]} for the frequency bin data set used in ICA of the second stage

A separation process of the first stage in Step S104 is a process of executing a separation process by performing learning of ICA for the frequency bins included in the frequency bin data set Ω^{[1st]} selected in the frequency bin classification process of Step S103. It is a process of the first-stage separation section 175 shown in FIG. 5. Details of the process will be described later. ICA in the stage is basically the same process as ICA of the related art (for example, “Apparatus and Method for Separating Audio Signals or Eliminating Noise” of Japanese Unexamined Patent Application Publication No. 2006-238409) except for the point that frequency bins are limited.

A separation process of the second stage in the next Step S105 is a process of executing a separation process by performing learning for the frequency bins included in the frequency bin data set Ω^{[2nd]} selected in the frequency bin classification process of Step S103. It is a process of the second-stage separation section 180 shown in FIG. 5. Details of the process will be described later. In the stage, a process with computational cost smaller than in the common ICA is performed by using a time envelope of the separation results obtained in the learning of the first stage and weighted covariance matrices calculated therefrom.

A re-synthesizing process of Step S106 is a process of generating separation matrices and separation results for all frequency bins by synthesizing the separation results (or the separation matrices) of the first and second stages. In addition, a process after the learning and the like are performed in the stage. The process is executed by the re-synthesis unit 182 shown in FIG. 5. Details of the process will be described later.

After the separation results for all frequency bins are generated, an inverse Fourier transform (inverse FT) process is performed in Step S107, and the results are converted into separation results (that is, a waveform) in the time domain. The process is performed by the inverse Fourier transform unit (inverse FT unit) 155 shown in FIG. 4. The separation results in the time domain are used in the latter process in Step S108 depending on the necessity.

As described above with reference to FIG. 4, the inverse Fourier transform (inverse FT) process of Step S107 may be omitted by the latter process. For example, when speech recognition is performed in the latter stage, STFT included in a module for the speech recognition and inverse FT of Step S107 can be omitted together. In other words, the separation results in the time frequency domain may be directly transferred to the speech recognition.

After the process from Steps S101 to S108 end, it is determined whether or not the process is to be continued in Step S109, and when it is determined to be continued, the process returns to Step S101, and repeated. When it is determined to be ended in Step S109, the process ends.

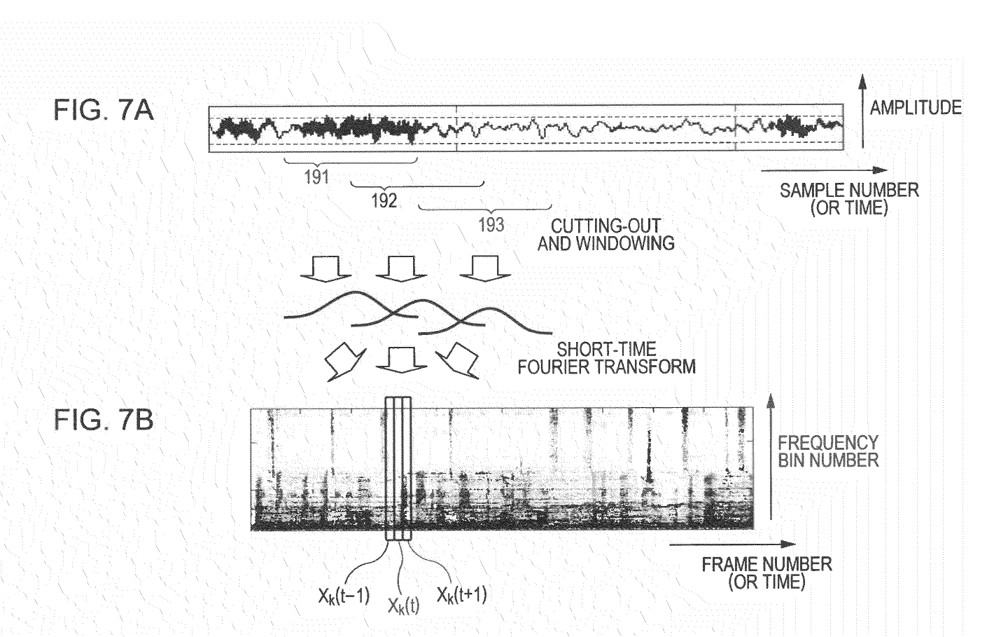

Next, details of the short-time Fourier transform process executed in Step S101 will be described with reference to FIGS. 7A and 7B.

For example, the observation signal xₖ(*) collected by k-th microphone in the environment shown in FIG. 1 is shown in FIG. 7A. k is the microphone number. In frames 191 to 193 which are segmented data obtained by segmenting a certain length from the observation signal xₖ(*), a window function such as Hanning window, sine window, or the like is made to affect. Furthermore, a segmented unit is called a frame. By performing short-time Fourier transform for data of one frame, a spectrum xₖ(t) that is data of the frequency domain, is obtained (t is the frame number).

Overlapping portion as the frames 191 to 193 shown in FIG. 7A may be exist between the segmented frames, and by doing that, spectrums xₖ(t−1) to xₖ(t+1) of consecutive frames can be smoothly changed. In addition, gathering of spectrums arranged according to frame numbers is called a spectrogram. FIG. 7B is an example of a spectrogram.

Furthermore, when there are overlapping portions between segmented frames in short-time Fourier transform (STFT), results with the inverse transform (waveforms) are overlapped for each frame also in inverse Fourier transform (FT). This is called overlap-add. The inverse transform results may be affected again by the window functions such as the sine window and the like before the overlap-add, and it is called weighted overlap-add (WOLA). With WOLA, noise derived from discontinuity between frames can be reduced.

Next, the frequency bin classification process which is the process of Step S103 shown in the flowchart of FIG. 6 will be described. The frequency bin classification process of Step S103 is a process of determining which of learning between in the first stage and in the second stage (or both) M-number of frequency bins are used, and a process executed by the frequency bin classification unit 173 shown in FIG. 5. The criterion of classification will be described with reference to Formula [8.1] and others below.

$$\begin{matrix}{Ω}^{[ 1 st ]} = \{ β , α + β , … , N α + β , … , {N}_{max} α + β , … \} & [ 8.1 ] \\ {Ω}^{[ 1 st ]} = \{ {ω}_{min} , … , {ω}_{max} \} & [ 8.2 ] \\ {σ ( ω )}^{2} = {\sum }_{k = 1}^{n} {\sum }_{ω = 1}^{M} {\sum }_{t = 1}^{T} {\vert {X}_{k} ( ω , t ) \vert}^{2} & [ 8.3 ] \\ {Ω}^{[ 2 nd ]} = \{ 1 , … , M \} - {Ω}^{[ 1 st ]} & [ 8.4 ] \\ {Ω}^{[ 2 nd ]} = \{ 1 , … , M \} & [ 8.5 ]\end{matrix}$$

Formulas [8.1] to [8.3] are classification methods (selection methods) for frequency bins used in the learning of the first stage.

Formula [8.1] is an example of employing frequency bins in every α-number.

α and β indicates constant integers and N is an integer equal to or larger than 0,

where α>1 and 0<=β<α, and the maximum value of N of Nₘₐₓ is a maximized value satisfying Nₘₐₓ α+β<=M.

For example, if α=4, β=2, and M=257, frequency bin numbers: ω=2, 6, 10, . . . , 254 are used in the learning of the first stage.

Formula [8.2] is an example of using only observation signals in the limited frequency domain in the first stage. There are largely two cases where such band limitation is effective.

The first case is the latter part process, in other words, a case where the frequency domain is matched in a frequency band to be used in the output device (or a latter part processing unit) 156 shown in FIG. 4. For example, when a process executed by the output device (or a latter part processing unit) 156 is a speech recognition process, and for example, frequency component in the range of 300 Hz to 3400 Hz are mainly used (the same as the band in a telephone circuit), ωₘᵢₙ and ωₘₐₓ of Formula [8.2] are set to values corresponding to 300 Hz and 3400 Hz each. For example, in the case of sampling frequency=16 kHz and the number of frequency bins M=257, ωₘᵢₙ=10 and ωₘₐₓ=110.

The second case is a case where the frequency of an interrupting sound to be removed is generally expressed. For example, it is generally expressed that the frequency of the interrupting sound is limited to 1000 kHz to 2000 kHz, ωₘᵢₙ and ωₘₐₓ are set to values corresponding to 1000 Hz and 2000 Hz each. For example, when sampling frequency=16 kHz and the number of frequency bins M=257, ωₘᵢₙ=33 and ωₘₐₓ=64.

Instead of using a fixed frequency bin, a selective method in which a frequency bin including a component of great power is used can be used. For example, a selective method in which only frequency bins having a certain degree of power or more are selected to be used without using frequency bins including only a component of small power.

For this process, Formula [8.3] is used to calculate a variance for each frequency bin of observation signals (power). The formula is calculated for each frequency bin number ω, thereby obtaining σ(1)² to σ(M)². The values are sorted in descending order, and frequency bins from the top to a predetermined ranking may be used.

Within the three kinds of methods above, plural methods may be combined. For example, if Formulas [8.1] and [8.2] are combined, frequency bins between ωₘᵢₙ and ωₘₐₓ are employed at every α-number. In addition, if the methods of Formulas [8.2] and [8.3] are combined, upper rankings in the power order from the frequency bins between ωₘᵢₙ and ωₘₐₓ are employed.

Formulas [8.4] and [8.5] are classification criterion (selection criterion) of frequency bins used in the learning of the second stage.

As a basic process example, the learning of the second stage is performed for frequency bins that have not been used in the first stage. In other words, Formula [8.4] may be used.

However, the learning of the second stage may be performed for all frequency bins. In other words, the learning of the second stage of all included frequency bins may be performed for the frequency bins subjected to the learning of the first stage. The frequency bin data set of this case can be seen by Formula [8.5].

Furthermore, when the learning of the second stage of all included frequency bins is performed for the frequency bins subjected to the learning of the first stage, the learning results of the second stage is used as the final results.

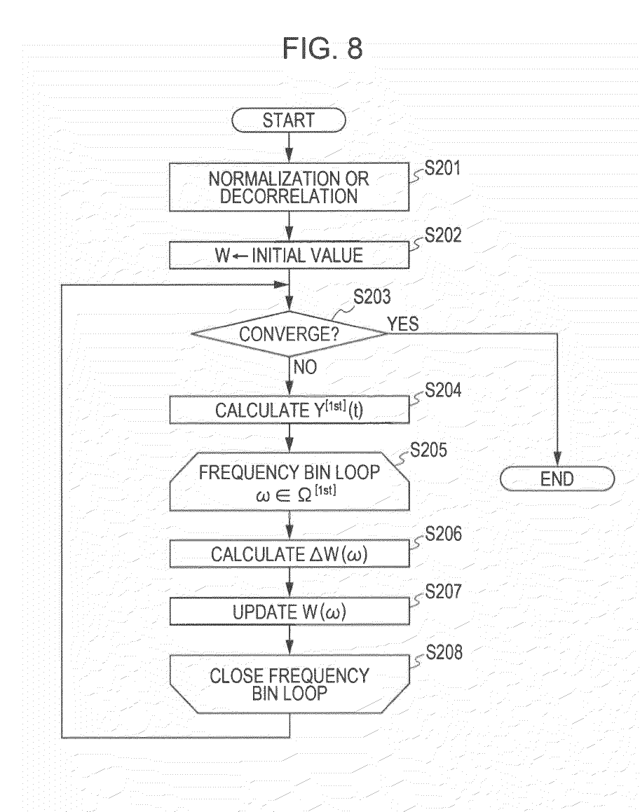

Next, details of the separation process of the first stage in Step S104 of the flowchart shown in FIG. 6 will be described using the flowchart shown in FIG. 8. The process is an application of ICA (refer to Japanese Unexamined Patent Application Publication No. 2006-238409, or the like) that has a characteristic of generating separation results with consistent permutation, and in Step S103 of the flow shown in FIG. 6, a process of separation signals is performed by performing learning according to ICA for frequency bins that belong to the frequency bin data set Ω^{[1st]} selected as the separation target of the first stage.

In Step S201 of the flow shown in FIG. 8, as preparation before learning, normalization and decorrelation are performed for observation signals depending on the necessity. Normalization is a process of adjusting a variance of the observation signals to 1, and performed as a process to which Formulas [9.1] and [9.2] shown below are applied.

$$\begin{matrix}{X}_{k}^{′} ( ω , t ) = \frac{{X}_{k} ( ω , t )}{{σ}_{k} ( ω )} & [ 9.1 ] \\ {σ}_{k} ( ω ) = {( {\sum }_{t = 1}^{T} {\vert {X}_{k} ( ω , t ) \vert}^{2} )}^{1 / 2} & [ 9.2 ] \\ {X}^{′} ( ω , t ) = P ( ω ) X ( ω , t ) & [ 9.3 ] \\ {〈 {X}^{′} ( ω , t ) {{X}^{′} ( ω , t )}^{H} 〉}_{t} = I & [ 9.4 ] \\ R ( ω ) = {〈 X ( ω , t ) {X ( ω , t )}^{H} 〉}_{t} & [ 9.5 ] \\ R ( ω ) = {VDV}^{H} & [ 9.6 ] \\ P ( ω ) = {VD}^{- 1 / 2} {V}^{H} & [ 9.7 ] \\ Y ( ω , t ) = W ( ω ) {X}^{′} ( ω , t ) = W ( ω ) P ( ω ) X ( ω , t ) & [ 9.8 ]\end{matrix}$$

Decorrelation is a process of applying conversion so as to make covariance matrices of the observation signals the identity matrix, and performed by Formulas [9.3] to [9.8] shown above. In other words, the covariance matrices of the observation signals are calculated with Formula [9.5], and eigenvalue decomposition expressed by Formula [9.6] is performed for the covariance matrices, where V is a matrix formed with eigenvectors, and D is a diagonal matrix having eigenvalues in a diagonal element.

If a matrix P(ω) expressed by Formula [9.7] is calculated by using the matrixes V and D, P(ω) becomes a matrix which decorrelates X(ω, t). In other words, letting X′(ω, t) be the result obtained by applying P(ω) to X(ω, t) (Formula [9.3]), the covariance matrix of X′(ω, t) is the identity matrix (Formula [9.4]).

Hereinbelow, the observation signal X(ω, t) included in the formula applied in the process of Steps S202 to 208 of the flow shown in FIG. 8 can also be expressed by an observation signal X′(ω, t) obtained by decorrelating or normalizing the observation signal X(ω, t).

Next, in Step S202, an initial value is substituted for the separation matrix W corresponding to the frequency bins included in the frequency bin data set ω^{[1st]} which is the processing target of the separation process of the first stage. The initial value may be the identity matrix, but when there is a separation matrix obtained in the previous learning, the value may be used as an initial value.

Steps S203 to 208 are a loop indicating learning, and the steps are repeatedly performed until the separation matrices and the separation results converge, or for a predetermined number of iteration determined in advance.

In Step S204, separation results Y^{[1st]}(t) are obtained. The separation results Y^{[1st]}(t) are separation results in the middle of the learning of the first stage, and expressed by Formula [4.12] shown above, where ω₁ to ω_{M[1st]} are elements of the frequency bin data set Ω^{[1st]} which is the processing target of the separation process of the first stage. In order to obtain Y^{[1st]}(t), Formula [3.1] may be applied to ω that belongs to Ω^{[1st]}. In addition, in this step, a norm of Yₖ^{[1st]}(t) is also obtained by using Formula [4.4].

Steps S205 to S208 are a loop for frequency bins, and Steps S206 and S207 are executed for ω that belongs to Ω^{[1st]}. Since the loop does not have dependency on orders, the process may be performed in parallel instead of the loop. It is the same for the loop of frequency bins hereinbelow.

In Step S206, ΔW(ω), the change of the separation matrix W(ω), is calculated. Specifically, ΔW(ω) is calculated by using Formula [4.5], where the score function appearing in the formula is calculated by Formulas [4.6] to [4.8]. As described above, φ_{ω}(Yₖ(t)) is called a score function, and is a logarithmic differentiation of a multi-dimensional (multivariate) probability density function (PDF) of Yₖ(t) (Formula [3.6]).

Furthermore, other formula than Formula [4.5] can be applied to the calculation of ΔW(ω). Other calculation methods will be described later.

Next, in Step S207, the separation matrix W(ω) is updated. To be more specific, Formula [3.3] shown above is applied thereto.

After the process of Steps S205 to S206 are executed for all frequency bins ω included in the frequency bin data set Ω^{[1st]} which is the processing target of the separation process of the first stage, the process returns to Step S203. After the process of determining whether or not the learning is converged is repeated a certain number of times, the process is branched by a furcation advancing to the right, and the learning process of the first stage ends.

Herein, a case where a formula other than Formula [4.5] is applied in a calculation process of Δ W(ω), the change of the separation matrix W(ω), in Step S206 will be described. Formula [4.5] is based on an algorithm called a natural gradient method, but above-described Formula [4.10], which is based on “Equivariant Adaptive Separation via Independence” as another algorithm, can be applied thereto, where Q(ω) included in Formula [4.10] is a matrix calculated in Formula [4.9].

In addition, in a case where decorrelation (a process according to Formulas [9.3] to [9.7] described above) is performed as a pre-process, since the separation matrix W(ω) is limited to an orthonormal matrix (a matrix satisfying W(ω)W(ω)^{H}=I), another algorithm with early convergence can be applied. Furthermore, H in W(ω)^{H} indicates Hermite transpose.

As another algorithm with early convergence, for example, Formula [4.11] which is a gradient algorithm based on orthonormality constraints can be applied. Q(ω) in the formula is calculated by Formula [4.9], but the element of Y^{[1st]}(t) and Y(ω,t) of Formula [4.9] are calculated not by Formula [3.1], but by Formula [9.8].

Now, the description of the separation process of the first stage ends.

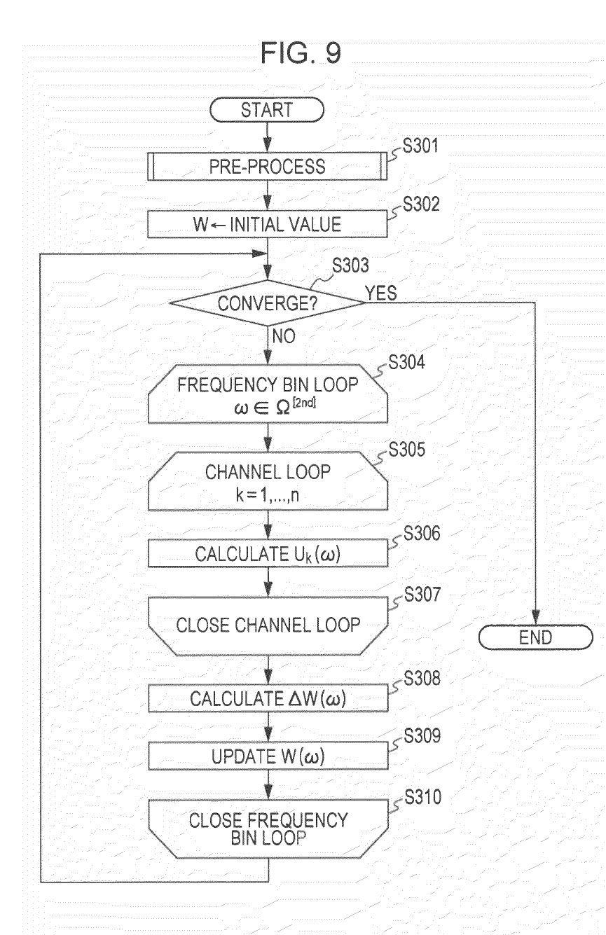

Next, details of the separation process of the second stage in Step S105 in the flowchart of FIG. 6 will be described with reference to the flowchart of FIG. 9. The process uses the envelope obtained from the separation results of the first stage as reference information (reference), and realizes the separation of signals with small computational cost and maintaining the same separation accuracy as in the case where general ICA is applied.

The target of the separation process of the second stage is frequency bins that belong to the frequency bin data set Ω^{[2nd]} selected as separation targets of the second stage in Step S103 of the flow in FIG. 6. As described above, as a basic process example, the learning of the second stage is performed for frequency bins that are not used in the first stage. In other words, Formula [8.4] may be used, where the learning of the second stage may be performed for all frequency bins. In other words, the learning of the second stage may be performed for all included frequency bins for frequency bins completed with the learning of the first stage. The frequency bin data set in this case can be indicated by Formula [8.5]. Furthermore, in the case where the learning of the second stage is performed for all included frequency bins for frequency bins completed with the learning of the first stage, the learning results of the second stage is used as the final results.

Details of the separation process of the second stage will be described with reference to the flow shown in FIG. 9.

In the pre-process of Step S301, first, the same process as the process of Step S201 in FIG. 8 described as the process of the first stage before is performed. In other words, normalization and decorrelation are performed for the observation signals depending on the necessity. Furthermore, in addition to the processes, the amount of the envelope of the separation results of the first process (Formula [5.1]), the weighted covariance matrices of the observation signals (Formula [7.7]), and the like are calculated in the pre-process of the separation process of the second stage, before the learning of the separation process of the second stage. Furthermore, details of the process will be described later.

Next, in Step S302, an initial value is substituted for the separation matrix W(ω) corresponding to frequency bins included in the frequency bin data set Ω^{[2nd]} that is the processing target of the separation process of the second stage. The initial value may be the identity matrix, but in a case where separation matrices obtained in the previous learning exist, the value may be used as the initial value. In addition, in the same manner as the interpolation method in the related art, the audio source direction is presumed based on the separation matrices obtained in the separation process of the first stage, and a learning initial value may be generated based on the value of the audio source direction.

Steps S303 to S310 are a loop expressing learning, and repeatedly performed until the separation matrices and the separation results converge, or a predetermined number of iteration determined in advance. Steps S305 to S309 are executed for the frequency bin ω included in the frequency bin data set Ω^{[2nd]} that is the processing target of the separation process of the second stage.

Steps S305 to 307 are a loop for channels, and if Uₖ(ω) indicated in Formula [7.9], that is,

Uₖ(ω)=−Wₖ(ω)Cₖ(ω)W(ω)^{H}

is calculated in Step S306, U(ω) of Formula [7.10] is obtained when the loop is omitted.

In Step S308, ΔW(ω), the change of the separation matrix W(ω), is calculated. To be more specific, Formula [7.11] is used. Other formula can be applied thereto, but for that matter, description will be provided in the subject of [3. Modified Example of the Signal Processing Device of the Present Invention] later.

Next, in Step S207, the separation matrix W(ω) is updated. To be more specific, Formula [3.3] described above is applied thereto.

After the process of Steps S305 to S309 are executed for the frequency bin ω included in the frequency bin data set Ω^{[2nd]} that is the processing target of the separation process of the second stage, the process returns to Step S303. After the process of determining whether or not the learning is converged is repeated a certain number of times, the process is branched by a furcation advancing to the right, and the learning process of the second stage ends.

Furthermore, in the separation process of the second stage, the order can be shifted between the loop of the learning and the loop of the frequency bins.

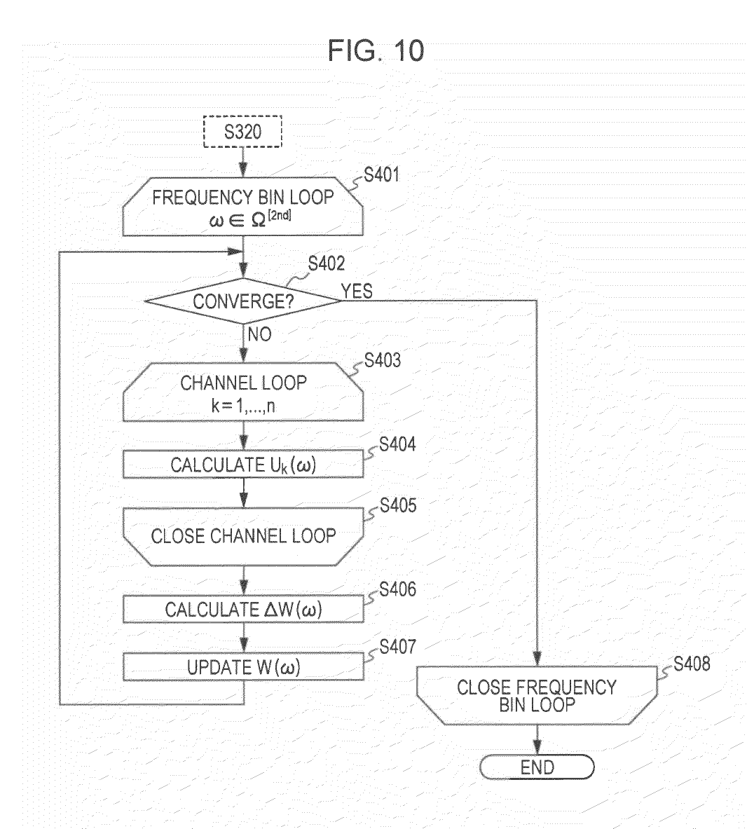

In other words, the flow shown in FIG. 9 is a flow having the loop of the frequency bins (S304 to S310) inside and the loop of the learning (S303 to S310) outside, but a process having the loop of the frequency bins outside and the loop of the learning inside is possible. This flowchart is shown in FIG. 10.

The process flow shown in FIG. 10 will be described. After the process of Step S301 (pre-process) and Step S302 (setting of the initial value of the separation matrix W(ω)) in the flow of FIG. 9, the process of Step S401 and thereafter shown in FIG. 10 is executed.

The flow shown in FIG. 10 has a structure having the loop of the frequency bins (S401 to S408) outside and the loop of the learning (S402 to S408) inside.

In the flowchart shown in FIG. 10, the inside of the loop of the frequency bins can be operated in a plurality of parallels as a process of each frequency bin unit. For example, by using a system having a plurality of CPU cores, each learning process of frequency bin ω included in the frequency bin data set Ω^{[2nd]} that is the processing target of the separation process of the second stage can be operated in parallel. For this reason, the time consumed for the learning of the second stage can be reduced in comparison to a case where the loop of the frequency bins is sequentially executed.

Furthermore, since it is necessary for the separation results Y^{[1st]} (t) to be calculated every time in the learning loop in the separation process of the first stage described with reference to the flowchart of FIG. 8, the order of the loop is not able to be shifted.

Now, the description of the entire sequence of the separation process of the second stage ends.

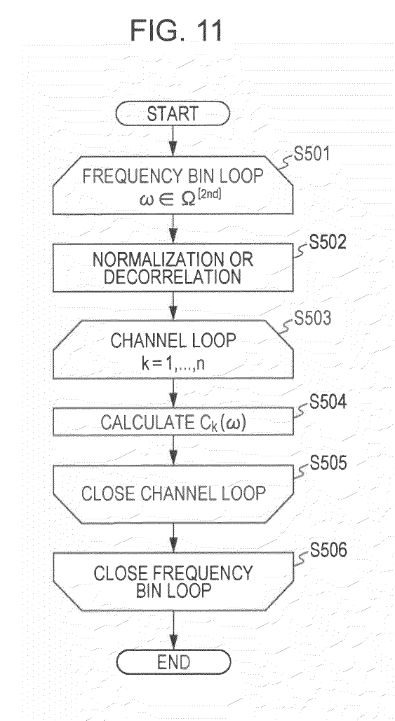

Next, the pre-process executed in the separation process of the second stage, that is, details of the pre-process executed in Step S301 of the flowchart shown in FIG. 9 will be described with reference to the flowchart shown in FIG. 11.

Steps S501 to S506 are a loop for the frequency bins, and Steps S502 to S505 are executed for the frequency bin ω included in the frequency bin data set Ω^{[2nd]} that is the processing target of the separation process of the second stage.

The normalization or decorrelation of Step S502 is the same process as that of Step S201 of FIG. 8 described as the process of the first stage before. In other words, the normalization or decorrelation is performed for the observation signals depending on the necessity. In other words, Formulas [9.1] and [9.2] (normalization) or Formulas [9.3] to [9.7] (decorrelation) shown above are applied to the observation signals depending on the necessity.

Steps S503 to S505 are a loop of channels, and for k=1, . . . , n, Cₖ(ω) applicable as a score function in the learning process of the second stage is obtained by using Formula [7.7] shown above. Furthermore, as described above, Cₖ(ω) in Formula [7.7] is a result of averaging X(ω, t)X(ω, t)^{H} with the weight 1/rₖ(t) where rₖ(t) is the envelope obtained in the process of the first stage, and Cₖ(ω) is a “weighted covariance matrix (of observation signals)”.

Furthermore, in a case where normalization or decorrelation is performed in Step S502, data X(ω, t) indicating the observation signals of Formula [7.7] is a value after the normalization or decorrelation is performed. Refer to Formula [10.2] shown below.

$$\begin{matrix}Δ W ( ω ) = {〈 {ϕ}^{[ 2 nd ]} ( Y ( ω , t ) ) {Y ( ω , t )}^{H} - Y ( ω , t ) {{ϕ}^{[ 2 nd ]} ( Y ( ω , t ) )}^{H} 〉}_{t} W ( ω ) & [ 10.1 ] \\ {C}_{k}^{′} ( ω ) = {γ}^{[ 2 nd ]} {〈 \frac{1}{{r}_{k} ( t )} {X}^{′} ( ω , t ) {{X}^{′} ( ω , t )}^{H} 〉}_{t} & [ 10.2 ] \\ = P ( ω ) {C}_{k} ( ω ) {P ( ω )}^{H} & [ 10.3 ] \\ {U}_{k}^{′} ( ω ) = - {W}_{k} ( ω ) {C}_{k}^{′} ( ω ) {W ( ω )}^{H} & [ 10.4 ] \\ {U}^{′} ( ω ) = [ \begin{matrix}{U}_{1}^{′} ( ω ) \\ ⋮ \\ {U}_{n}^{′} ( ω )\end{matrix} ] & [ 10.5 ] \\ Δ W ( ω ) = \{ {U}^{′} ( ω ) - {{U}^{′} ( ω )}^{H} \} W ( ω ) & [ 10.6 ]\end{matrix}$$

In Step S506, the loop of the frequency bins is closed. Now, the description of the detailed process of the pre-process (Step S301 in the flow shown in FIG. 9) executed in the separation process of the second stage ends.

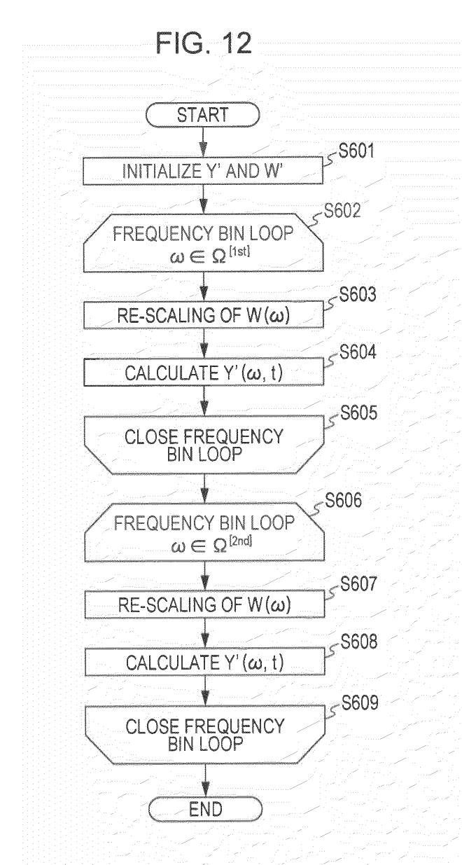

Next, details of the re-synthesis process of Step S106 in the overall process flow shown in FIG. 6 will be described with reference to the flowchart shown in FIG. 12.

The re-synthesis process of Step S106 is a process of generating the separation matrices and the separation results of all frequency bins by synthesizing each of the separation results (or the separation matrices) of the first and the second stage. In addition, a re-scaling process (a process of adjusting scale between frequency bins) as a post-process of learning is also executed.

First of all, in Step S601, the separation matrices after the re-synthesis are set to W′, and the separation results after the re-synthesis to Y′, and an initialization process for allocating areas of each pieces of data is performed.

Steps S602 to S605 are a loop of frequency bins, and Steps S603 and S604 are executed for the frequency bin ω included in the frequency bin data set Ω^{[1st]} that is the processing target of the separation process of the first stage.

Furthermore, in a case where there is a common element in the frequency bin data set Ω^{[1st]} that is the processing target of the separation process of the first stage and in the frequency bin data set Ω^{[2nd]} that is the processing target of the separation process of the second stage, Steps S603 and S604 may be skipped for the common element. It is because the value is to be a superscript in the loop for the Ω^{[2nd]} thereafter.

For example, as the frequency bin data set Ω^{[2nd]} that is the processing target of the separation process of the second stage, when Formula [8.5] (in other words, all frequency bins) shown above is used, since all elements of the Ω^{[1st]} overlap the Ω^{[2nd]}, Steps S602 to S605 may all be skipped.

In Step S603, the following two processes are performed.

When the normalization or the decorrelation is performed for the observation signals in the pre-process in the separation process of the first stage (Step S201 of FIG. 8) described above and in the pre-process in the separation process of the second stage (Step S301 of FIG. 9), separation matrices updating process is executed that reflects the coefficient or the matrices into the separation matrices.

Formula [11.1] shown below is a formula indicating the separation matrices updating process in a case where the normalization process is executed for the observation signals. Formula [11.2] is a formula indicating the separation matrices updating process in a case where the decorrelation process is executed for the observation signals.

$$\begin{matrix} W ( ω ) ← diag ( \frac{1}{{σ}_{1}} , … , \frac{1}{{σ}_{n}} ) W ( ω ) & [ 11.1 ] \\ W ( ω ) ← P ( ω ) W ( ω ) & [ 11.2 ] \\ B ( ω ) = [ \begin{matrix}{B}_{11} ( ω ) & ⋯ & {B}_{1 n} ( ω ) \\ ⋮ & ⋱ & ⋮ \\ {B}_{n 1} ( ω ) & ⋯ & {B}_{nn} ( ω )\end{matrix} ] = {W ( ω )}^{- 1} & [ 11.3 ] \\ {W}^{′} ( ω ) = diag ( {B}_{i 1} ( ω ) , … , {B}_{in} ( ω ) ) W ( ω ) & [ 11.4 ] \\ {Y}^{′} ( ω , t ) = {W}^{′} ( ω ) X ( ω , t ) & [ 11.5 ] \\ B ( ω ) = {〈 X ( ω , t ) {Y ( ω , t )}^{H} 〉}_{t} diag ( \frac{1}{{〈 {Y}_{1} ( ω , t ) \overline{{Y}_{1} ( ω , t )} 〉}_{t}} , … , \frac{1}{{〈 {Y}_{n} ( ω , t ) \overline{{Y}_{n} ( ω , t )} 〉}_{t}} ) & [ 11.6 ] \\ = R ( ω ) {W ( ω )}^{H} diag ( \frac{1}{{W}_{1} ( ω ) R ( ω ) {{W}_{1} ( ω )}^{H}} , … , \frac{1}{{W}_{n} ( ω ) R ( ω ) {{W}_{n} ( ω )}^{H}} ) & [ 11.7 ]\end{matrix}$$

By executing such a separation matrix updating process, the separation matrix W(ω) is converted from a matrix for separation the observation signal X′(ω,t) obtained by making the observation signal X(ω,t) subjected to normalization or decorrelation into a matrix for separating the observation signal X(ω,t).

Next, B(ω), which is the inverse matrix of the separation matrix W(ω), is calculated (Formula [11.3]), and a separation matrix W′(ω) subjected to re-scaling is obtained by multiplying a diagonal matrix, which takes the i-th row of B(ω) as its diagonal elements, by W(ω) (Formula [11.4]). Wherein, i is the number of a projection-back target microphone. The meaning of “projection” will be described later.

In Step S603, the separation matrix W(ω), which has been subjected to re-scaling, is obtained, and in the next Step S604, the separation result Y′(ω,t), which has been subjected to re-scaling, is obtained by using Formula [11.5]. The process is performed for all frames.

Herein, the meaning of “projection” will be described. Projecting the separation results Yₖ(ω,t) before re-scaling into a microphone i is to presume a signal observed by the microphone i when only an audio source corresponding to the separation results Yₖ(ω,t) is assumed to make a sound. In other words, the scale in each frequency bin of the separation results of each channel is matched with the scale of observation signals when only one audio source corresponding to the separation result is active.

In Step S605, the loop of the frequency bins is closed.

Steps S606 to S609 are a loop of frequency bins, and Steps S607 and S608 are executed for the frequency bin ω that belongs to the frequency bin data set ω^{[2nd]} that is the separation processing target of the second stage. Since the Steps S607 and S608 are the same processes as Steps S603 and S604 described above, description thereof will not be repeated.

When Step S609 ends, all frequency bins and the separation matrices and the separation results that have been subjected to re-scaling are stored in each of the separation matrix W(ω) and the separation result Y′(ω,t).

The description of the process ends here.

### [3. Modified Example of the Signal Processing Device of the Present Invention]

Next, a modified example of the signal processing device of the present invention will be described.

As a modified example of the signal processing device of the invention, there are two kinds of modified examples (1) and (2) as below.

(1) Other algorithm is used in the signal separation process of the second stage.

(2) Other method than ICA is used in the signal separation process of the first stage.

Furthermore, as an algorithm applied to the signal separation process of the second stage used in the modified example (1), for example, there are following algorithms.

(1a) EASI

(1b) Gradient Algorithm with Orthonormality Constraints

(1c) Fixed-Point Algorithm

(1d) Closed Form

Hereinbelow, the modified example of the above will be described.

[3-1. Modified Example using Another Algorithm in a Signal Separation Process of a Second Stage]

First of all, the modified example using another algorithm in the signal separation process of the second stage will be described. In the embodiment described above, the natural gradient method algorithm to which Formulas [7.1] to [7.11] are applied in the signal separation process of the second stage was used. In the signal separation process of the second stage, the EASI, the gradient algorithm with orthonormality constraints, the fixed-point algorithm, the closed form, and the like can be applied in addition to the natural gradient method algorithm. Hereinafter, the algorithms will be described.

(1a) EASI

EASI is the abbreviation of “Equivariant Adaptive Separation via Independence”. The formula of EASI of the past is as Formula [12.1] shown below, but in the learning of the second stage of the invention, it is use by modifying Formula [12.1] into Formula [12.3].

ΔW(ω)= [symbol] I−Y(ω,t)Y(ω,t)^{H}+φ^{[2nd]}(Y(ω,t))Y(ω,t)^{H}−Y(ω,t)φ^{[2nd]}(Y(ω,t))^{H} [symbol] W(ω) [12.1]

R(ω)= [symbol] X(ω,t)X(ω,t)^{H} [symbol] [12.2]

ΔW(ω)={I−W(ω)R(ω)W(ω)^{H}+U(ω)−U(ω)^{H}}W(ω) [12.3]

Wherein, R(ω) in Formula [12.3] is a covariance matrix of observation signals calculated by Formula [12.2], and U(ω) is a matrix calculated by Formulas [7.9] and [7.10]shown above. Since the amount including an average between frames <>ₜ can be calculated before learning in those formulas, the computational cost of Formula [12.3] is smaller than that of Formula [12.1].

(1b) Gradient Algorithm with Orthonormality Constraints

In a case where decorrelation (Formulas [9.3] to [9.7]) is performed for the pre-process (Step S301 of the flow shown in FIG. 9) in the signal separation process of the second stage, since the separation matrix W(ω) is limited to an orthonormal matrix (a matrix satisfying W(ω)W(ω)^{H}=I), another algorithm with early convergence can be applied. Herein, a case where a gradient method is applied based on orthonormality constraints will be described.

The formula of the gradient algorithm with orthonormality constraints of the related art is as Formula [10.1] shown above, but in the learning of the second stage of the invention, it can be modified as Formula [10.6], where U′(ω) of Formula [10.6] is calculated by Formulas [10.4] and [10.5], and Cₖ′(ω) of Formula [10.4] is calculated by Formulas [10.2] and [10.3]. The computational costs of these formulas are smaller than Formula [10.1].

(1c) Fixed-Point Algorithm

On the premise of decorrelation, other algorithm that limits a separation matrix into an orthonormal matrix also exits. Herein, the fixed-point algorithm will be described. The algorithm is a method for directly updating the separation matrix W(ω) instead of ΔW(ω) that is a difference of the separation matrix, and in general, is a process for performing updating expressed by Formula [13.1] shown below.

$$\begin{matrix}W ( ω ) ← orthonormal ( {〈 - {ϕ}^{[ 2 nd ]} ( Y ( ω , t ) ) {{X}^{′} ( ω , t )}^{H} 〉}_{t} ) & [ 13.1 ] \\ B = orthonormal ( A ) & [ 13.2 ] \\ {BB}^{H} = I & [ 13.3 ] \\ {G}_{k} ( ω ) = - {W}_{k} ( ω ) {C}_{k}^{′} ( ω ) & [ 13.4 ] \\ G ( ω ) = [ \begin{matrix}{G}_{1} ( ω ) \\ ⋮ \\ {G}_{n} ( ω )\end{matrix} ] & [ 13.5 ] \\ W ( ω ) ← orthonormal ( G ( ω ) ) & [ 13.6 ]\end{matrix}$$

Wherein, orthonormal() in Formula [13.1] expresses an operation for converting the matrix in the parenthesis into an orthonormal matrix (converted into a unitary matrix for a matrix having complex number values). In other words, letting B be the return value of orthonormal(A) (Formula [13.2]), B satisfies Formula [13.3].

When the formula is used in the learning of the second stage of the invention, it can be converted into a form with a small computational cost. The modified formula is expressed by Formulas [13.4] to [13.6], where Cₖ′(ω) included in Formula [13.4] is calculated by Formulas [10.2] and [10.3] described above in the same manner as the case of the gradient algorithm with orthonormality constraints.

(1d) Closed Form

In the separation process of the second stage, the separation matrix W(ω) can be obtained by a closed form (a formula not using repetition). The method will be described with reference to the following formula.

$$\begin{matrix}\{ \begin{matrix}W ( ω ) {C}_{1} ( ω ) {W ( ω )}^{H} = I \\ ⋮ \\ W ( ω ) {C}_{n} ( ω ) {W ( ω )}^{H} = I\end{matrix} & [ 14.1 ] \\ C = {\sum }_{k = 1}^{n} {C}_{k} ( ω ) & [ 14.2 ] \\ C = {V}^{′} {D}^{′} {V}^{′ H} & [ 14.3 ] \\ F = {V}^{′} {D}^{′ - 1 / 2} {V}^{′ H} & [ 14.4 ] \\ G = {F}^{H} {C}_{k} ( ω ) F & [ 14.5 ] \\ G = {V}^{″} {D}^{″} {V}^{″ H} & [ 14.6 ] \\ W ( ω ) = {( {FV}^{″} {DV}^{″ - 1 / 2} )}^{H} & [ 14.7 ]\end{matrix}$$

C₁(ω) to Cₙ(ω) of Formula [14.1] each are matrixes defined by Formula [7.7]. When the matrix W(ω) satisfies each formula of Formula [14.1] at the same time, ΔW(ω)=0 is obtained if such W(ω) is substituted for Formula [7.11]. In other words, W(ω) satisfying Formula [14.1] at the same time is formed with one value when the learning expressed by Formula [7.11] converges. Formula [14.1] is called joint diagonalization of matrices, and is generally expressed to be solved by the closed form according to the following procedure.

The sum of C₁(ω) to Cₙ(ω) is set to C (Formula [14.2]). Next, a matrix C to the power of −½ is calculated, and the result is set to F. To be more specific, eigenvalue decomposition is applied to the matrix C (Formula [14.3]), and F is obtained from the result by Formula [14.4].

Next, a matrix G defined by Formula [14.5] is obtained. In the formula, Cₖ(ω) may be a matrix of C₁(ω) to Cₙ(ω), and it is mathematically demonstrated to finally obtain the same W(ω) by using any matrix. If the eigenvalue decomposition is applied to the matrix G, and calculation is performed for the right side of Formula [14.7] by using the result thereof, the result of the calculation is the aimed separation matrix W(ω).

If Formula [14.7] is substituted for the left side of Formula [14.1], and the relationship of Formulas [14.4] to [14.6] is used, the identity matrix is obtained, and therefore, W(ω) obtained in Formula [14.7] is the solution of Formula [14.1].

Furthermore, please refer to the following theses for details of the method of obtaining separation matrices by the joint diagonalization. The difference between the following theses and the present invention is that, in the former, covariance matrices of observation signals calculated in each of a plurality of zones is subjected to joint diagonalization, but in the latter, a plurality of weighted covariance matrixes differently weighted in the same zone is subjected to joint diagonalization.

“Real-time Blind Source Extraction with Learning Period Detection based on Closed-Form Second-Order Statistic ICA and Kurtosis” by Yuuki Fujiwara, Yu Takahashi, Kentaro Tachibana, Shigeki Miyabe, Hiroshi Saruwatari, Kiyohiro Shikano, and Akira Tanaka, IEICE Transactions on Fundamentals of Electronics, Communications and Computer Sciences, Vol. J92 to A, No. 5, pp. 314˜326, the issued date of May 1, 2009

[3-2. Modified Example using Other Methods than ICA in the Signal Separation Process of a First Stage]

As described above with reference to FIGS. 3A to 3C, the time envelope is calculated from the separation results obtained in the separation of the first stage in the separation of the second stage of the invention, and the results of the calculation are used in learning. To put it differently, if the time envelope can be calculated, it is not necessary for the separation of the first stage to be executed based on ICA, and further, it is not necessary for the separation results to be obtained for each frequency bin.

Herein, a method of using directional microphones in the signal separation process of the first stage as an audio source separation method other than ICA will be described.

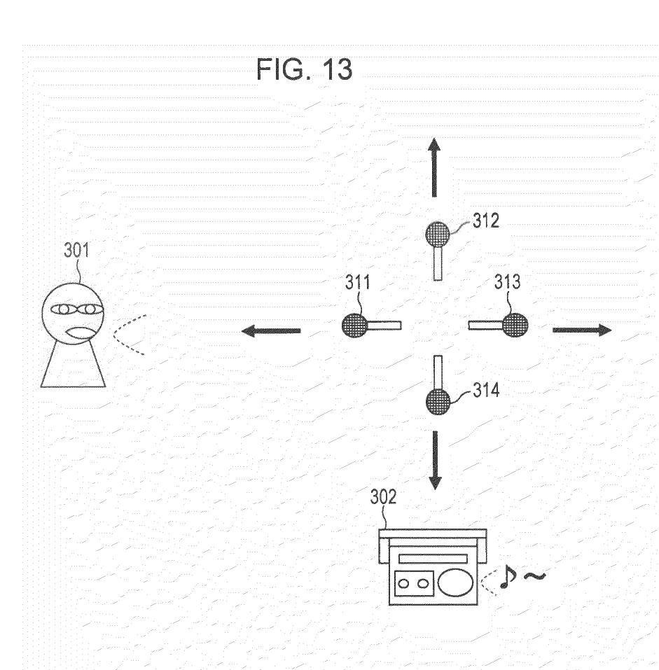

FIG. 13 is an example of arrangement of directional microphones. 311 to 314 are directional microphones and each of them is assumed to have directivity in the arrow directions. 301 of an audio source 1 is observed most intensively by 311 of a microphone 1, and 302 of an audio source 2 is observed most intensively by 314 of a microphone 4. However, other microphones also observed the intensity of the directivity to some degree. For example, the sound of 301 of the audio source 1 is mixed to observation signals of 312 of a microphone 2 and 314 of the microphone 4 to some degree.

Thus, time envelopes are generated from the observation signals of the directional microphones, and if the separation of the second stage is performed by using the envelopes, separation results are obtained with high accuracy. Specifically, the results obtained by applying STFT to the observation signals of 311 of the microphone 1 to 314 of the microphone 4 are set to observation signals X₁(ω,t) to X₄(ω,t), a time envelope rₖ(t) is calculated for each of them by using Formula [15.1] shown below. The rₖ(t) obtained here is used in the signal separation process of the second stage.

$${r}_{k} ( t ) = {( {\sum }_{ω ∈ {Ω}^{[ 1 st ]}} {\vert {X}_{k} ( ω , t ) \vert}^{2} )}^{1 / 2} \qquad [ 15.1 ]$$

The process of the case advances as follows.

First of all, the observation signals in the time frequency domain are generated by STFT for the mixtures of the output signals from the plurality of audio sources acquired by the plurality of directional microphones.

Furthermore, the audio source separation unit calculates an envelope equivalent to a power change in a time direction for channels corresponding to each of the directional microphones from the observation signals, and acquires separation results by executing a learning process in which separation matrices for separating the mixtures are calculated with the use of a score function obtained by setting the envelope to a fixed value. The separation process is the same process as the separation process described with reference to FIG. 9 or 10.

Furthermore, directional microphones are used in the example, but instead, directivity, blind areas, and the like may be dynamically formed by using a technique of beamforming by a plurality of microphones.

### [4. Explanation of Effect by a Signal Process of the Present Invention]

Next, the effect by a signal process of the invention will be described.

Description will be provided that the method of the invention (separation in two stages) obtains the same separation results as the case where ICA is applied to all frequency bins as the method of the past, by using actual data.

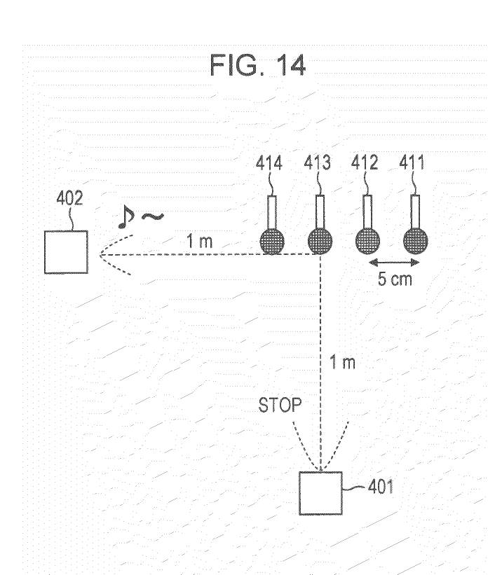

FIG. 14 shows an environment of collection. Four microphones (411 of a microphone 1 to 414 of a microphone 4) are installed at the interval of 5 cm. Speakers are installed at two positions 1 m apart from 413 of a microphone 3. They are a front speaker (audio source 1) 401 and a left speaker (audio source 2) 402.

A voice saying “Stop” is made from the front speaker (audio source 1) 401 and music is played from the left speaker (audio source 2) 402.

Collection is performed while each of the audio sources are individually made, and the mixture of waveforms is performed by a calculator. The sampling frequency is 16 kHz, and the length of observation signals is 4 seconds.

STFT uses 512 as the number of points and 128 as a shift width. If this STFT is caused to activate in the data of 4 seconds, a spectrogram with the number of frequency bins of 257 and the number of frames of 249 is generated.

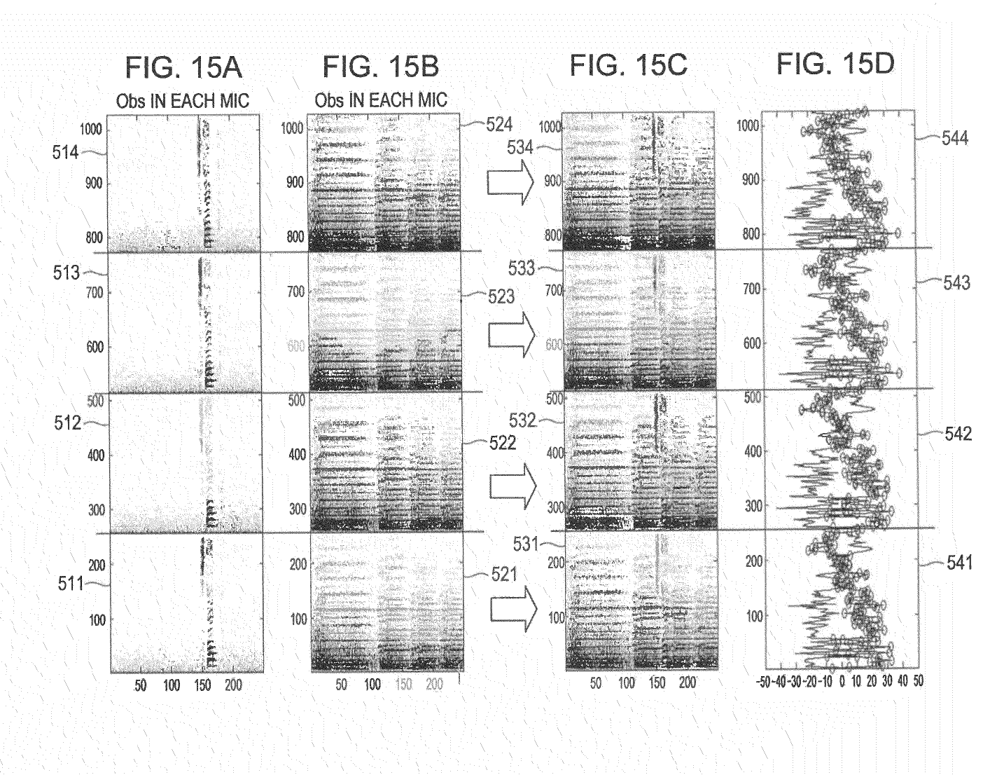

FIGS. 15A to 15D show a spectrogram of the source signals and observation signals obtained as experimental results in the collecting environment shown in FIG. 14. FIGS. 15A to 15D show the following signals:

(a) Components derived from the front speaker (audio source 1) 401

(b) Components derived from the left speaker (audio source 2) 402

(c) Observation signals

(d) Signal-to-Interference Ratio (SIR)

In the signals (a) to (c), the horizontal axis stands for frames, and the vertical axis stands for frequencies, and frequencies get higher upward in the vertical axis. (d) SIR will be described latter.

Signals 511 to 514 shown in (a) components derived from the front speaker (audio source 1) 401 are signals observed by each of the microphones (411 of the microphone 1 to 414 of the microphone 4) at the same time when the voice saying “stop” is made from the front speaker (audio source 1) 401. The voice of “stop” is output only at one moment, and the portion is indicated by black vertical lines.

Signals 521 to 524 shown in (b) components derived from the left speaker (audio source 2) 402 are signals observed by each of the microphones (411 of the microphone 1 to 414 of the microphone 4) at the same time when the “music” is played from the left speaker (audio source 2) 402. Since the music is continuously output, observation signals expanding in the horizontal direction are obtained as a whole.

(c) observation signals are signals observed by each of the microphones (411 of the microphone 1 to 414 of the microphone 4) at the same time as observation signals in a case where the voice saying “stop” is made from the front speaker (audio source 1) 401 at the same time when the “music” is played from the left speaker (audio source 2) 402. (c) observation signals are expressed as the combination of the signals (a) and (b).

(d) SIR is a spectrogram plotted with SIR for each frequency bin. SIR is a value expressing what power ratio source signals are mixed by a common logarithm in the target signals (the observation signals for each frequency bin in this example). For example, when the audio source 1 and the audio source 2 are mixed at a power ratio of 1:10 in the observation signals in a frequency bin:

SIR for the audio source 1 is 10 log(1/10)=−10, and

SIR for the audio source 2 is 10 log(10/1)=10.

In FIG. 15D, the broken lines with circles shown in the substantially right sides indicate SIR for the left speaker (audio source 2) 402. The broken lines with no mark in the left sides indicate SIR for the front speaker (audio source 1) 401. The vertical axis stands for frequencies, and the upper direction stands for higher frequencies. It can be understood that, for the observation signals, the sound from the audio source 2 (the left speaker (audio source 2) 402) is superior in most frequency bins, and frequency bins in which the audio source 1 (the front speaker (audio source 1) 401) is superior are limited to a part of a higher domain based on the SIR data shown in FIG. 15D.

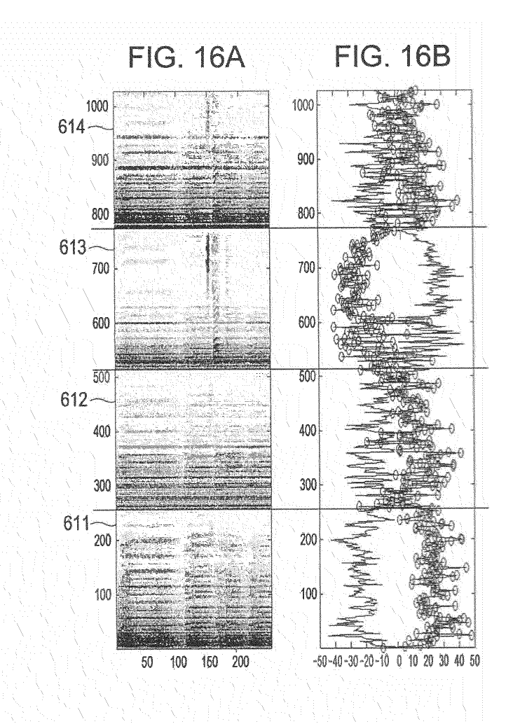

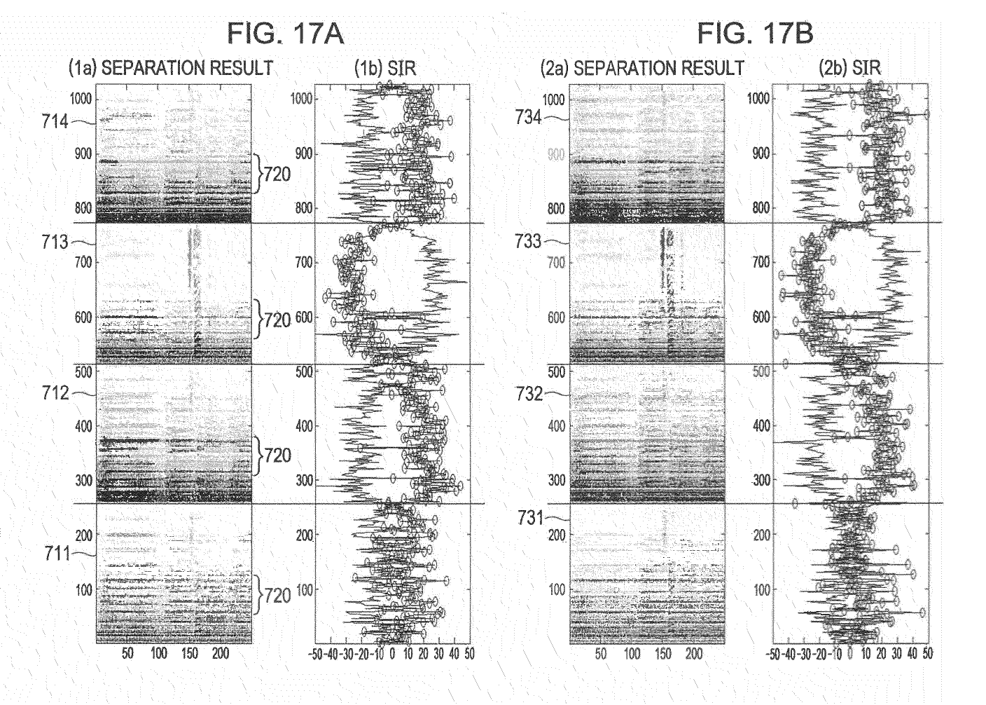

Next, in a circumstance where the observation signals are obtained as shown in FIGS. 15A to 15B under the collecting environment shown in FIG. 14, data of the following will be described with reference to FIGS. 16A and 16B and FIGS. 17A and 17B.

(A) Separation results when the signal separation process of the past is performed

(B) Separation results when the separation process is performed according to the invention

FIGS. 16A and 16B show separation results when the separation process is performed by ICA accompanying with the same learning process in all frequency domains, that is, the signal separation process of the past. After the decorrelation is applied to all frequency bins, Formula [4.11] is applied. The number of times of the loop is 150.

Among separation results 611 to 614 shown in (a) separation results of four channels, the sound of the front speaker (audio source 1) 401 (“stop”) is represented by the separation results 613.

In addition, the sound corresponding to the left speaker (audio source 2) 402 (music) is represented by the separation results 611. Furthermore, the separation results 612 and 614 are components close to silence, not corresponding to any audio source, and when the number of microphones (=4) is greater than the number of audio sources (=2), such signals appear in the separation results.

Next, FIGS. 17A and 17B show the separation results according to the invention. FIGS. 17A and 17B show the following data:

(1) (1a) separation results and (1b) SIR when frequency bins as separation processing targets are thinned out by ¼ in the signal separation process of the first stage

(2) (2a) separation results and (2b) SIR when frequency bins as separation processing targets are thinned out by 1/16 in the signal separation process of the first stage.

The computational cost in the case where the frequency bins are thinned out by ¼ is reduced to about ¼ in comparison to the past method, and the computational cost in the case where the frequency bins are thinned out by 1/16 is reduced to about 1/16 in comparison to the past method.

In separation results 711 to 714 shown in (1a) separation results in the case where the frequency bins as the separation processing targets are thinned out by ¼, the learning of the first stage is performed for frequency bins of 720 equivalent to 2 kHz to 4 kHz, and the learning of the second stage is performed for all frequency bins (refer to Formula [8.5]). The gradient algorithm with orthonormality constraints (Formula [4.11]) is used in the learning of the first stage, and EASI (Formula [12.3]) is used in the learning of the second stage. The repetition number is 150 in both cases.

In this experiment, the sound of the front speaker (audio source 1) 401 (“stop”) appears in the separation results 713, and the sound corresponding to the left speaker (audio source 2) 402 appears in the separation results 712.

In addition, in separation results 731 to 734 shown in (2a) separation results in the case where the frequency bins as the separation processing targets are thinned out by 1/16, the learning of the first stage is performed only for more ¼ frequency bins of the frequency bins of 720 equivalent to 2 kHz to 4 kHz. The selection method of frequency bins is the combination of Formulas [8.1] and [8.2], and furthermore, α is set to 4 in Formula [8.2]. As a result, the frequency bins in the learning of the first stage are thinned out by 1/16.

The learning of the second stage is performed for all frequency bins (refer to Formula [8.5]). The gradient algorithm with orthonormality constraints (Formula [4.11]) is used in the learning of the first stage, and EASI (Formula [12.3]) is used in the learning of the second stage. The iteration count is 150 in both cases.

In this experiment, the sound of the front speaker (audio source 1) 401 (“stop”) appears in the separation results 733, and the sound corresponding to the left speaker (audio source 2) 402 appears in the separation results 732 and 734.

As such, the present invention can reduce the computational cost while keeping the same separation accuracy as that in the conventional methods (in which ICA is applied to all frequency bins) by combining the separation of the first stage (ICA in limited frequency bins) and the separation of the second stage (learning that uses a time envelope calculated from separation results of the first stage).

Hereinabove, the present invention has been described in detail with reference to specific embodiments. However, it is obvious that a person skilled in the art can conceive of modifications or substitutions to the embodiments not departing from the gist of the invention. In other words, the invention is disclosed in the form of examples, and is not supposed to be interpreted as limited thereto. Claims of the invention are supposed to be considered in order to judge the gist of the invention.

In addition, a series of processes described in the specification can be executed in the form of hardware, software, or a combined configuration of the both. When a process is to be executed by software, a program recorded with a processing sequence can be executed by being installed in a memory of a computer into which dedicated hardware is incorporated, or a program can be executed by being installed in a general-purpose computer available for various processes. For example, such a program can be recorded on a recording medium in advance. In addition to installation on a computer from a recording medium, such a program can be received through a network such as a local area network (LAN), or the Internet, and installed on a recording medium such as a built-in hard disk or the like.

The various processes described in the specification may be executed not only in a time series as the description but also in parallel or individually according to the processing capacity of the device executing the processes or the necessity. In addition, a system in the present specification has a logically assembled structure of a plurality of units, and is not limited to units of each structure accommodated in the same housing.

The present application contains subject matter related to that disclosed in Japanese Priority Patent Application JP 2010-082436 filed in the Japan Patent Office on Mar. 31, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A signal processing device comprising:
a signal transform unit which generates observation signals in the time frequency domain by acquiring mixtures of the output signals from a plurality of audio sources with a plurality of sensors and applying short-time Fourier transform (STFT) to the acquired signals; and
an audio source separation unit which generates audio source separation results corresponding to each audio source by a separation process for the observation signals,
wherein the audio source separation unit includes
a first-stage separation section which calculates separation matrices that separate mixtures included in the first frequency bin data set selected from the observation signals by a learning process in which Independent Component Analysis (ICA) is applied to the first frequency bin data set, and acquires first separation results for the first frequency bin data set by applying the calculated separation matrices,
a second-stage separation section which acquires second separation results for the second frequency bin data set selected from the observation signals by using a score function in which an envelope, which is obtained from the first separation results generated in the first-stage separation section and represents power modulation in the time direction for channels corresponding to each of the sensors, is used as a fixed one, and by executing a learning process for calculating separation matrices for separating mixtures included in the second frequency bin data set, and
a synthesis section which generates the final separation results by integrating the first separation result calculated by the first-stage separation section and the second separation result calculated by the second-stage separation section.

2. The signal processing device according to claim 1, wherein the second-stage separation section acquires second separation results for the second frequency bin data set selected from the observation signals by using a score function which uses the envelope as its denominator and by executing a learning process for calculating separation matrices for separating mixtures included in the second frequency bin data set.

3. The signal processing device according to claim 1 or 2, wherein the second-stage separation section calculates separation matrices used for separation in the learning process for calculating separation matrices for separating mixtures included in the second frequency bin data set so that an envelope of separation results Yₖ corresponding to each of channel k is similar to an envelope rₖ of separation results of the same channel k obtained from the first separation result.

4. The signal processing device according to claim 1 or 2, wherein the second-stage separation section calculates weighted covariance matrices of observation signals, in which the reciprocal number of each sample in the envelop obtained from the first separation results is used as the weight, and uses the weighted covariance matrices of the observation signals as a score function in the learning process for acquiring the second separation results.

5. The signal processing device according to any one of claims 1 to 4, wherein the second-stage separation section executes a separation process by setting observation signals other than the first frequency bin data set, which is the target of the separation process in the first-stage separation section as the second frequency bin data set.

6. The signal processing device according to any one of claims 1 to 4, wherein the second-stage separation section executes a separation process by setting observation signals including overlapping frequency bins with the first frequency bin data set, which is the target of the separation process in the first-stage separation section as the second frequency bin data set.

7. The signal processing device according to any one of claims 1 to 6, wherein the second-stage separation section acquires the second separation results by a learning process in which the natural gradient algorithm is utilized.

8. The signal processing device according to any one of claims 1 to 6, wherein the second-stage separation section acquires the second separation results in a learning process in which the Equivariant Adaptive Separation via Independence (EASI) algorithm, the gradient algorithm with orthonormality constraints, the fixed-point algorithm, or the joint diagonalization of weighted covariance matrices of the observation signals is utilized.

9. The signal processing device according to any one of claims 1 to 8, comprising:
a frequency bin classification unit which performs setting of the first frequency bin data set and the second frequency bin data set,
wherein the frequency bin classification unit performs
(a) a setting where frequency bands used in the latter process is to be included in the first frequency bin data set;
(b) a setting where frequency bands corresponding to known interference sound is to be included in the first frequency bin data set;
(c) a setting where frequency bands containing components with large power is to be included in the first frequency bin data set; and
a setting of the first frequency bin data set and the second frequency bin data set according to any setting of (a) to (c) above or a setting formed by combining a plurality of settings from (a) to (c) above.

10. A signal processing device comprising:
a signal transform unit which generates observation signals in the time frequency domain by acquiring mixtures of the output signals from a plurality of audio sources with a plurality of sensors and by applying short-time Fourier transform (STFT) to the acquired signals; and
an audio source separation unit which generates audio source separation results corresponding to each audio source by a separation process for the observation signals,
wherein the plurality of sensors are each directional microphones, and
wherein the audio source separation unit acquires separation results by calculating an envelope corresponding to power modulation in the time direction for channels corresponding to each of the directional microphones from the observation signals, using a score function obtained by using the envelope as a fixed one, and by executing a learning process for calculating separation matrices for separating the mixtures.

11. A signal processing method performed in a signal processing device comprising the steps of:
transforming signal in which a signal transform unit generates observation signals in the time frequency domain by applying short-time Fourier transform (STFT) to mixtures of the output signals from a plurality of audio sources acquired by a plurality of sensors; and
separating audio sources in which an audio source separation unit generates audio source separation results corresponding to audio sources by a separation process for the observation signals,
wherein the separating of audio sources includes the steps of
first-stage separating in which separation matrices for separating mixtures included in the first frequency bin data set selected from the observation signals are calculated by a learning process in which Independent Component Analysis (ICA) is applied to the first frequency bin data set, and the first separation results for the first frequency bin data set is acquired by applying the calculated separation matrices,
second-stage separating in which second separation results for the second frequency bin data set selected from the observation signals are acquired by using a score function in which an envelope, which is obtained from the first separation results generated in the first-stage separating and represents power modulation in the time direction for channels corresponding to each of the sensors, is used as a fixed one, and a learning process for calculating separation matrices for separating mixtures included in the second frequency bin data set is executed, and
synthesizing in which the final separation results are generated by integrating the first separation results calculated by the first-stage separating and the second separation results calculated by the second-stage separating.

12. A program which causes a signal processing device to perform a signal process comprising the steps of:
transforming signal in which a signal transform unit generates observation signals in the time frequency domain by applying short-time Fourier transform (STFT) to mixtures of the output signals from a plurality of audio sources acquired by a plurality of sensors; and
separating audio sources in which an audio source separation unit generates audio source separation results corresponding to audio sources by a separation process for the observation signals,
wherein the separating audio source includes the steps of
first-stage separating in which separation matrices for separating mixtures included in the first frequency bin data set selected from the observation signals are calculated by a learning process in which Independent Component Analysis (ICA) is applied to the first frequency bin data set, and the first separation results for the first frequency bin data set are acquired by applying the calculated separation matrices,
second-stage separating in which second separation results for the second frequency bin data set selected from the observation signals are acquired by using a score function in which an envelope, which is obtained from the first separation results generated in the first-stage separating and represents power modulation in the time direction for channels corresponding to each of the sensors, is used as a fixed one, and a learning process for calculating separation matrices for separating mixtures included in the second frequency bin data set is executed, and
synthesizing in which the final separation results are generated by integrating the first separation results calculated by the first-stage separating and the second separation results calculated by the second-stage separating.
